(19) United States
(12) Patent Application Publication
(10) Pub. No.: US 2010/0199805 A1
(43) Pub. Date: Aug. 12, 2010

(54) CONTINUOUSLY VARIABLE TRANSMISSION

(76) Inventor: Robert Charles Downs, La Jolla, CA (US)

Correspondence Address: TIMOTHY L. SMITH, 14740 CAMINITO PORTA DELGADA, DEL MAR, CA, 92014, US

(21) Appl. No.: 12/302,486

(22) PCT Filed: May 30, 2007
(86) PCT No.: PCT/US2007/013003

§ 371 Date: Nov. 25, 2008

Related U.S. Application Data
(60) Provisional application No. 60/803,386, filed on May 30, 2006.

(51) Int. Cl. F16H 21/20

(52) U.S. Cl. 74/837

(57) ABSTRACT

This invention provides continuously variable transmissions and associated powertrains and automotive transmission systems. Included among the transmission systems provided are efficient transmissions for employing regenerative braking.

### BACKGROUND OF THE INVENTION

A 1200 kg vehicle is typically designed with an engine with a power output of approximately 100 Horsepower (HP). This is the case in spite of the fact that only about 10 HP is needed to propel the vehicle at a steady speed of 100 km/hr. The extra reserve power is needed to accelerate the vehicle from rest and to propel the vehicle up inclines.

This state of affairs is quite inefficient with regard to fuel consumption as internal combustion engines achieve maximum fuel efficiency when operating at or near their maximum power output. A 100 HP engine is very inefficient while producing only 10 HP.

Hybrid electric vehicles offer improved efficiency by reducing the size of the internal combustion engine (to about 70 HP in this example) and supplementing the peak power requirements with and electric motor/generator and battery system. (30 HP) The gas engine is shut off completely during idling and very low speed operation—consuming no fuel whatsoever. When maximum acceleration is required, both the gas engine and electric motor/generator are used together to obtain 100 HP. During most other operating situations, the internal combustion engine operates alone and also recharges the battery system by driving the motor/generator. In these situations, the internal combustion engine operates closer to its maximum efficiency point than a 100 HP engine would.

These two fuel saving modes represent a fairly significant overall fuel saving over a conventional vehicle particularly if a large portion of low speed and/or stop and go driving is being performed.

Using a process known as regenerative braking can also save some energy. In this process, the electric generator on the vehicle is used to slow the vehicle during braking maneuvers, storing some energy in the battery system that otherwise would have been entirely wasted as heat in the friction brakes.

If it were possible to recover most or all of this vehicle kinetic energy normally lost in braking, very large energy savings would result. In practice, hybrid electric vehicles recover only a fraction of this energy. This is primarily due to two factors. First, the many steps of energy conversation each introduce cumulative losses that add up to a significant loss. Kinetic (mechanical) energy must first be converted to electric energy. Then the electric energy must be transformed in the power electronics. Then this transformed electric energy must be converted to chemical energy in the battery system. Then to get useful work from this stored energy, all these steps with their accompanying losses must be reversed and repeated. If each step had and average efficiency of 90%, the net efficiency of all of these six steps would be (0.9)⁶=50%.

Secondly, most practical battery systems have limitations on the rate at which they can accept charging currents. A 1200 kg vehicle traveling at 100 km/hr represents about 1,000,000 joules of kinetic energy. To decelerate this vehicle to zero in a reasonable 10 seconds and store all of the energy means the battery system would have to accept a power flux of 100 kilowatts for ten seconds. This is about an order of magnitude beyond what a battery sized for a hybrid vehicle could accept through charging.

If an energy storage system could be designed that would capture and use most or all of the kinetic energy normally lost during braking very large efficiencies could be realized. In theory, a vehicle could be constructed with an internal combustion engine downsized all the way to 10 or 20 HP. One key innovation required to bring this concept to fruition is a continuously variable transmission (CVT) with a very wide ratio coverage range and mechanical efficiencies comparable to a geared transmission. The invention described herein fulfils this and other needs.

### SUMMARY OF THE INVENTION

The invention provides a continuously variable transmission that includes: a) an input shaft that rotates relative to a reference frame; b) an input disk comprising a face and a rotational axis at a center of the face, wherein the input disk is operably connected to the input shaft such that the input disk rotates about the rotational axis, relative to the reference frame, when the input shaft rotates; c) a crank pin movably attached to the face of the input disk, wherein the crank pin is movable between at least a first position and a second position on the face of the input disk; and d) an output element that comprises: i) a bell crank that comprises an arm and a pivot end, ii) a connecting rod that connects the crank pin to an attachment point on the arm of the bell crank, iii) a one-way clutch attached to the pivot end of the bell crank, and iv) a clutch-driven shaft operably connected to the one-way clutch.

In some embodiments, when the crank pin is positioned on the face of the input disk at a position other than the center, rotation of the input disk causes the connecting rod to move in a reciprocating substantially linear motion, thereby causing the arm of the bell crank to oscillate in a first direction and a second direction opposite to the first direction, wherein movement of the arm of the bell crank in the first direction is transmitted by the one-way clutch to the clutch-driven shaft and movement of the arm of the bell crank in the second direction causes the one-way clutch to slip such that the movement of the bell crank is not transmitted to the clutch-driven shaft.

The continuously variable transmissions can also include an output shaft operably connected to the clutch-driven shaft, wherein rotational motion of the clutch-driven shaft is transmitted to the output shaft.

The transmissions can have one or more output elements attached to the crank pin. Typically, when two or more output elements are used, the output elements are positioned approximately equidistant from each other about the rotational axis of the input shaft. In multiple output element embodiments, the clutch-driven shafts are generally connected to a common output shaft by, for example, a gear mechanism, a chain and sprocket, or similar means.

In some embodiments, the continuously variable transmission include at least a second bell crank that comprises an arm, at least a second connecting rod that connects the crank pin to the arm of the second bell crank; and at least a second one-way clutch attached to the second bell crank. The second one-way clutch is operably connected to a clutch-driven shaft, which can be either the same clutch-driven shaft to which is attached the first bell crank or can be a second clutch-driven shaft.

The reference frames of the continuously variable transmissions can include a backing plate to which the clutch-driven shaft is attached. The input shaft in these embodiments can be fixed, while the backing plate rotates about the input shaft when a rotational force is applied to the clutch-driven shaft. If the crank pin is positioned at the center of the face of the input disk, the backing plate rotates at the same rotational speed as the clutch-driven shaft. However, when the crank pin is moved to a position other than the center of the input disk face, the backing plate will rotate at a reduced rotational speed compared to the rotational speed of the clutch-driven shaft.

The invention also provides a regenerative braking system that includes a driveshaft, a flywheel, an engine, and: a) a first continuously variable transmission configured to operate in overdrive mode to transmit rotational motion from the driveshaft to the flywheel; b) a second continuously variable transmission configured to operate in an underdrive mode to transmit rotational motion from the engine or the flywheel to a driveshaft; c) an engine input clutch; d) a flywheel input clutch; and e) an output clutch.

### DESCRIPTION OF THE DRAWINGS

FIGS. 1A and B show a continuously variable transmission that has a rotating input crankshaft 10 that is operably connected to an input disk 20 such that the input disk rotates about its center when the input crankshaft rotates. A crank pin 30 is movably positioned on a face of the input disk. In FIG. 1A, the crank pin is positioned at the axis of rotation of the input disk. In FIG. 1B, the crank pin is displaced to a second position on the face of the input disk.

FIGS. 2A-B shows a view of a connecting rod 40 attached to the crank pin 30. In FIG. 2A, the crank pin is positioned at the axis of rotation of the input disk 20, so the connecting rod does not move when the input disk rotates. In FIG. 2B, the crank pin is displaced to a position away from the axis of rotation of the input disk. Rotation of the input disk results in a reciprocating movement of the opposite end of the connecting rod.

FIGS. 3A-E show a continuously variable transmission that includes a bell crank 50 attached to an end of the connecting rod 40 opposite to the end that is attached to the crank pin 30. A one-way clutch 60 is attached to the bell crank. In FIG. 3A, the crank pin is positioned at the axis of rotation of the input disk so rotation of the input disk does not result in any movement of the bell crank and the output shaft 70 remains stationary. In FIGS. 3B-E, the crank pin has been repositioned to a second position on the face of the input disk. Rotation of the input disk results in reciprocating movement of the connecting rod, which in turn causes a back and forth rotational movement of the bell crank 50. The one-way clutch transmits only clockwise (in the illustrated embodiment) rotation of the bell crank to the output shaft 70.

FIG. 4 shows a time versus rotational speed output diagram of the continuously variable transmission shown in FIG. 3.

FIG. 5 shows an example of a continuously variable transmission having two output elements, each of which includes a connecting rod 40, a bell crank 50, a one-way clutch 60, and an output shaft 70.

FIG. 6 shows a time versus rotational speed output diagram of the continuously variable transmission shown in FIG. 5.

FIG. 7 shows an example of a continuously variable transmission having four output elements.

FIG. 8 shows a time versus rotational speed output diagram of the continuously variable transmission shown in FIG. 7.

FIG. 9 shows an example of a continuously variable transmission having eight output elements.

FIG. 10 shows a time versus rotational speed output diagram of the continuously variable transmission shown in FIG. 9.

FIG. 11 shows an example of a continuously variable transmission having two output elements that both drive the same output shaft 70.

FIG. 12 shows an example of a continuously variable transmission having four output elements, two of which drive each of two output shafts 70.

FIG. 13 shows an example of a continuously variable transmission in which a scotch yoke 90 is caused to reciprocate by the crank pin 30 when the input disk rotates. The scotch yoke includes a slot 80 into which the crank pin is inserted.

FIG. 14 shows an example of a continuously variable transmission that employs two scotch yokes to drive four output shafts.

FIG. 15 shows another embodiment of a continuously variable transmission that employs a scotch yoke to drive two output shafts.

FIG. 16 shows an embodiment of a continuously variable transmission that employs a scotch yoke to drive two output shafts.

FIG. 17 shows another embodiment of a continuously variable transmission that employs a scotch yoke to drive two output shafts.

FIG. 18 shows a further example of a continuously variable transmission that uses a scotch yoke to drive two output shafts.

FIG. 19 shows one embodiment of a continuously variable transmission acting in underdrive mode. A rotational input of 1000 rpm is applied to the input shaft 10. The crank pin 30 is positioned at the rotational axis of the input disk 20, however, so the rotation of the input shaft is not transmitted to the connecting rod 40 or ultimately to the driveshaft 110.

FIG. 20 shows the continuously variable transmission as illustrated in FIG. 19, but with the crank pin displaced slightly from the rotational axis of the input disk. The rotational movement of the input shaft is transmitted to the output shaft 110 at a ratio of 10:1.

FIG. 21 shows the continuously variable transmission of FIGS. 19 and 20 in which the crank pin is displaced further from the axis of rotation of the input disk. The rotational movement of the input shaft is transmitted to the driveshaft at a ratio of 1:1.

FIG. 22 shows an example of a continuously variable transmission that is acting as an overdrive. The crank pin 30 is positioned at the rotational axis of the input disk 20.

FIG. 23 shows the continuously variable transmission of FIG. 22 in which the crank pin 30 is displaced slightly from the rotational axis of the input disk 20.

FIG. 24 shows the continuously variable transmission, again acting in overdrive mode, in which the crank pin is displaced on the face of the input disk further from the rotational axis of the input disk than in the transmission shown in FIG. 23. The input applied to the drive shaft 110 is 100 rpm counterclockwise, which causes the output 100 to rotate counterclockwise at 1000 rpm.

FIG. 25 shows a continuously variable transmission having reverse gear functionality.

FIG. 26 shows an embodiment of a continuously variable transmission in which wheels drive an engine/flywheel at a 1:1 ratio. The crank pin is positioned on the face of the input disk 20 at the rotational axis of the input disk. A rotational input of 1000 rpm counterclockwise is applied through the driveshaft 110, resulting in output to the engine/flywheel of 1000 rpm clockwise (1:1 ratio).

FIG. 27 shows an embodiment of the continuously variable transmission in which wheels drive an engine/flywheel at a 3:5 ratio. The crank pin is displaced 10 nm from the rotational axis of the input disk.

FIG. 28 shows an embodiment of the continuously variable transmission in which wheels drive an engine/flywheel at a 1:10 ratio. The crank pin is now displaced 30 mm from the rotational axis of the input disk.

FIG. 29 shows an embodiment of the continuously variable transmission in which an engine/flywheel drives wheels at a 0:1 ratio. The crank pin is displaced 33.3 mm from the rotational axis of the input disk in this embodiment.

FIG. 30 shows an embodiment of the continuously variable transmission in which an engine/flywheel drives wheels at a 10:1 ratio. A rotational force applied to the main backing plate 100, with the crank pin positioned at 33.3 mm from the rotational axis of the input disk (⅓ the bell crank radius). The 3:1 gearing between the output shaft 70 and the drive shaft 110 results in a zero rotational force applied to the driveshaft.

FIG. 31 shows an embodiment of the continuously variable transmission in which a rotational input applied to the main backing plate 100, when the crank pin is positioned 50 mm from the rotational axis of the input disk (½ the bell crank radius), results in the driveshaft rotates at 500 rpm in the direction opposite to that in which the main backing plate rotates.

FIG. 32 shows an embodiment in which an engine/flywheel drives wheels in reverse at a 1:1 ratio. The crank pin is positioned 66.6 mm (⅔ the bell crank radius) from the rotational axis of the input disk. In this configuration, a 1000 rpm counterclockwise rotational force applied to the main backing plate 100 results in the driveshaft 110 rotating clockwise at 1000 rpm.

FIG. 33 shows a continuously variable transmission that includes a forward/reverse shifting gear unit. This shifting unit allows a single transmission to perform both overdrive and underdrive duties, with the reversing output as observed in FIGS. 30-32 negated by the reversing mechanism.

FIG. 34 shows another embodiment of a transmission that employs a forward/reverse shifting gear unit that allows the transmission to perform both overdrive and underdrive duties.

FIG. 35 shows a wide ratio underdrive transmission that can carry torque in both directions. In this configuration, the wheels drive the engine/flywheel at a 1:1 ratio with the crank pin radius at 0 mm.

FIG. 36 shows a wide-ratio underdrive transmission in a configuration in which the crank pin radius is set at 66.6 mm (⅔ the bell crank radius) and the output shaft 70 rotates in the direction opposite to that of the input. This reversal of the rotation is itself reversed using a reversing gearbox that has a ratio of 1:1. In contrast to the configuration shown in FIG. 35, in this embodiment the engine/flywheel drives the wheels.

FIG. 37 shows a transmission in which the wheels drive the engine/flywheel in overdrive mode. The crank pin radius is 16.66 mm (less than ⅓ the bell crank radius). The wheels impart a counterclockwise input of 1000 rpm to the driveshaft. This is transmitted to the engine/flywheel at a 1:2 ratio (output to engine/flywheel is 2000 rpm counterclockwise).

FIG. 38 shows a transmission in which the engine/flywheel drives the wheels. A 2000 rpm counterclockwise input is applied to the main backing plate when the crank pin is positioned at 50 mm (½ the bell crank radius) from the rotational axis of the input disk. The output shaft rotates at 1000 rpm clockwise (opposite direction to the input applied to the main backing plate, at a 2:1 ratio). A reversing gearbox is used to reverse the reversed intermediate output.

FIG. 39 shows a transmission in which the wheels drive the engine/flywheel at a 1:10 ratio. The crank pin radius is 30 mm (slightly less than ⅓ the bell crank radius of 100 mm). A counterclockwise rotation applied to the main backing plate by the engine/flywheel results in a clockwise rotation of the driveshaft of 1000 rpm.

FIG. 40 shows a transmission configured so that the engine/flywheel drive the wheels at a 1:10 ratio. The crank pin radius is 36.66 mm (between ⅓ and ½ of the bell crank radius). A 10,000 rpm counterclockwise input applied to the main backing plate is converted to an intermediate output of 1000 rpm clockwise (opposite direction) at the output shaft. The reversing gearbox converts this back to a counterclockwise rotation.

FIG. 41 shows a transmission configured so that the wheels attempt to drive the engine or flywheel at a 0:1 ratio. The crank pin radius is one third the bell crank radius, and since the chain ratio is 3:1, a counterclockwise input at the driveshaft 110 is locked, while a clockwise input results in the transmission freewheeling (no rotational input imparted to the engine or flywheel).

FIG. 42 shows a transmission configured so that an input applied to the main backing plate 100 (for example, by an engine or flywheel) drives the final drive shaft 142 (which can be connected to the wheels of a car) at a 1:0 ratio. The crankpin radius is set at one third the bell crank radius and the two sprockets and chain provide a 3:1 step-up in output to the driveshaft 110. For example, a 10,000 rpm counterclockwise input applied to the main backing plate results in a zero rpm clockwise output at the driveshaft. A reversing gearbox 143 provides a final output of zero rpm counterclockwise; the final drive shaft freewheels in the clockwise direction.

FIG. 43 shows two transmissions that are mechanically blended together into a single machine where they share a common input, reaction (crank pin moving mechanism) and output.

FIG. 44 shows a transmission having a gear type drive system with a typical overdrive to achieve a net 1:1 top ratio.

FIG. 45 also shows transmission having two output elements that are connected using a gear type drive system; when operated in a typical overdrive, this transmission achieves a net 1:1 top ratio.

FIG. 46 shows an eight-element embodiment of a transmission that uses a gear drive system to connect the output elements.

FIG. 47 shows an example of a continuously variable transmission that has a chain and sprocket arrangement to connect the two output elements.

FIG. 48 shows another example of a continuously variable transmission that uses a chain and sprocket arrangement to connect the four output elements.

FIG. 49 shows another example of a continuously variable transmission that uses a chain and sprocket arrangement to connect the eight output elements.

FIG. 50 shows example of a continuously variable transmission that uses a simplified output gear system that can be used in applications for which a reverse direction and a net underdrive output are acceptable.

FIG. 51 shows a four-element version of a continuously variable transmission that is suitable in applications for which reverse rotation is not acceptable.

FIG. 52 shows an eight-element version of a continuously variable transmission that is suitable in applications for which reverse rotation is not acceptable.

FIGS. 53A-C show three different views of one type of mechanism that is suitable for adjusting the position of the crank pin 30 on the face of the input disk 20. The crank pin is shown positioned at the rotational axis of the input disk 20, and the adjustment mechanism can move the crank pin across the face of the input disk.

FIGS. 54A-C show three different views of another example of a mechanism that is suitable for adjusting the position of the crank pin 30 on the face of the input disk 20.

FIG. 55 shows a mechanism that employs an electric motor to adjust the crank pin 30 position on the face of the input disk 20.

FIG. 56 shows a mechanism that uses a hydraulic cylinder 170 and piston 160 to adjust the position of the crank pin 30 on the face of the input disk 20.

FIG. 57 shows an example of a purely mechanical motion translation device for adjusting the position of the crank pin 30 on the face of the input disk 20.

FIG. 58 shows two views of an example of a continuously variable transmission in which multiple connecting rods 40 are attached to a single crank pin 30.

FIG. 59 shows two views of another example of a continuously variable transmission in which multiple connecting rods 40 are attached to a single crank pin 30.

FIG. 60 shows an example of an over-run/reversing mechanism.

FIG. 61 shows a variation on the overrun/reversing mechanism.

FIG. 62 shows one embodiment of a complete continuously variable transmission subunit.

FIG. 63 shows a basic automotive-type transmission in which a CVT subunit, configured in underdrive mode, is coupled to an over-run/reversing unit.

FIG. 64 shows another embodiment of an automotive-type transmission in which a CVT subunit is coupled to an over-run/reversing unit.

FIG. 65 shows a full automotive transmission system that includes flywheel energy storage for regenerative braking.

FIG. 66 shows another example of a full automotive transmission system that includes flywheel storage for regenerative braking.

FIG. 67 shows the results of an efficiency test for a CVT having eight output elements as described in the Example.

### DETAILED DESCRIPTION

This invention provides a continuously variable transmission (CVT). The transmission has pseudo-infinite ratio coverage. Speed reduction can theoretically be varied from 1:1 to 1:0. Moreover, by driving the output as an input and swapping the input and reaction members, one can invert the transmission with resulting speed ranges of 1:1 to 0:1. In this configuration the invention is an overdrive CVT that theoretically can achieve an infinite overdrive ratio. Very high overdrive ratios are practical with the transmission.

The transmission described herein is a positive drive design as opposed to a friction drive (belt, disk, ball) designs that were previously known. The continuously variable transmissions of the invention also lack movable fulcrums and levers that are found in previously known transmissions.

In some embodiments, the continuously variable transmission of the invention generally can carry torque in one direction at a given ratio setting. Should the output want to run faster than the input is driving it, the output will freewheel. For many applications this is not a disadvantage. In automotive applications, where engine braking is sometimes required, a fixed ratio gear set can be clutched in at a desired ratio to provide engine braking. Most current automatic transmissions also overrun in their gear ranges and need additional hardware to provide engine braking. This mechanism can be part of a reversing gear set that all current CVT designs currently need and incorporate in their practical designs. Also, a version of the transmission of the invention is described herein that can carry positive torque and negative torque. The switch from positive to negative torque can require a change in set point of the crank pin radius that may take a few seconds. Additionally, this version it permits the CVT to operate as an underdrive transmission and an overdrive transmission. Also, two separate transmission systems can be blended into a single mechanical assembly to carry torque in a bi-directional manner without time-consuming changes in operating mode. These last two configurations are ideally suited as a flywheel kinetic energy storage system for various vehicle configurations that will be discussed as practical applications.

Finally, the invention provides automotive transmission systems with flywheel energy storage for vehicle braking as a practical application of the continuously variable transmission. Two such systems are described in detail. The first system described requires separate underdrive and overdrive versions of the transmission, but fulfills all automotive requirements including reverse and overrun engine braking functions without additional, specialized hardware. The second system only requires one CVT unit configured for switching between both overdrive and underdrive modes, but also requires a reversing gear unit. Additionally, the switch between overdrive and underdrive modes in the second system takes a finite amount of time (1-2 seconds) versus immediate reaction in the system with separate CVT units.

### Continuously Variable Transmission—Principles of Operation

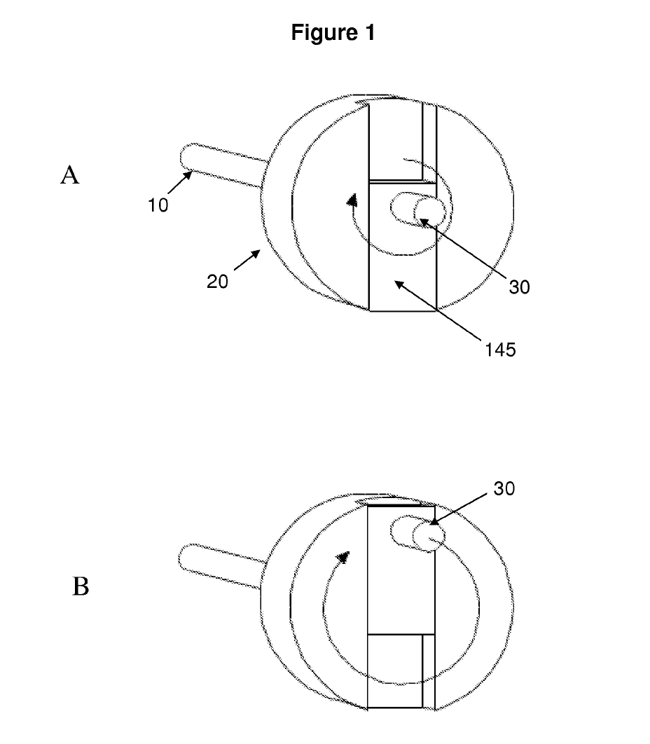

The transmission operates on the following principles of operation. First, rotary motion is converted to variable amplitude, linear reciprocating motion. The first element of this mechanism is a rotating input shaft 10 that is operably connected to an input disk 20 such that the input disk rotates about its center when the input crankshaft rotates. A crank pin 30 is movably attached to a face of the input disk such that the crank pin can be positioned anywhere from the exact center of the input disk (FIG. 1A) to a maximum position offset from center (FIG. 1B).

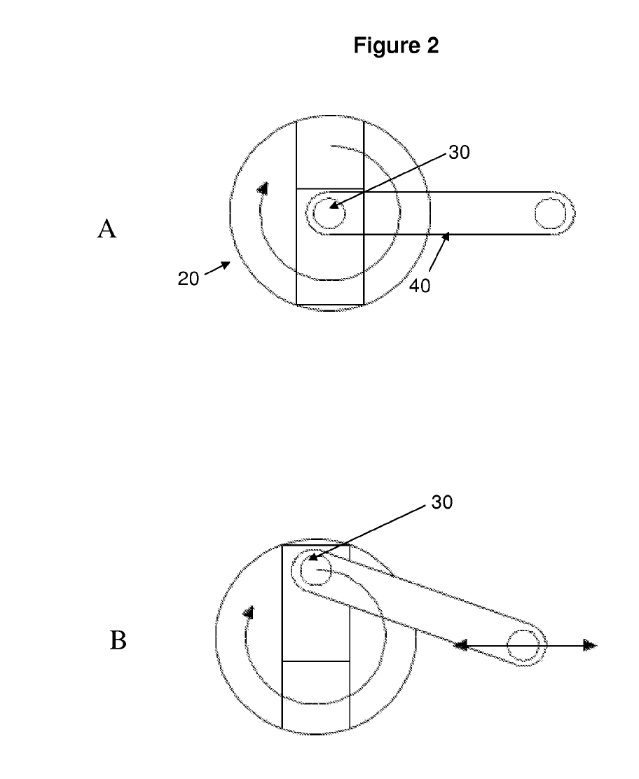

A connecting rod 40 is attached to the adjustable crank pin 30 as shown in FIG. 2, thereby converting the rotating motion of the crank pin to a reciprocating linear motion. The amplitude of this linear motion can vary from zero, when the crank pin is positioned at the center of the input disk 20 (FIG. 2A), to twice the maximum distance between the center of the input disk and the position of the crank pin (FIG. 2B). The resulting continuously variable transmission can continuously and infinitely vary its output speed from zero to a maximum value. In doing so, it converts a smoothly turning rotary motion to sinusoidal reciprocating motion.

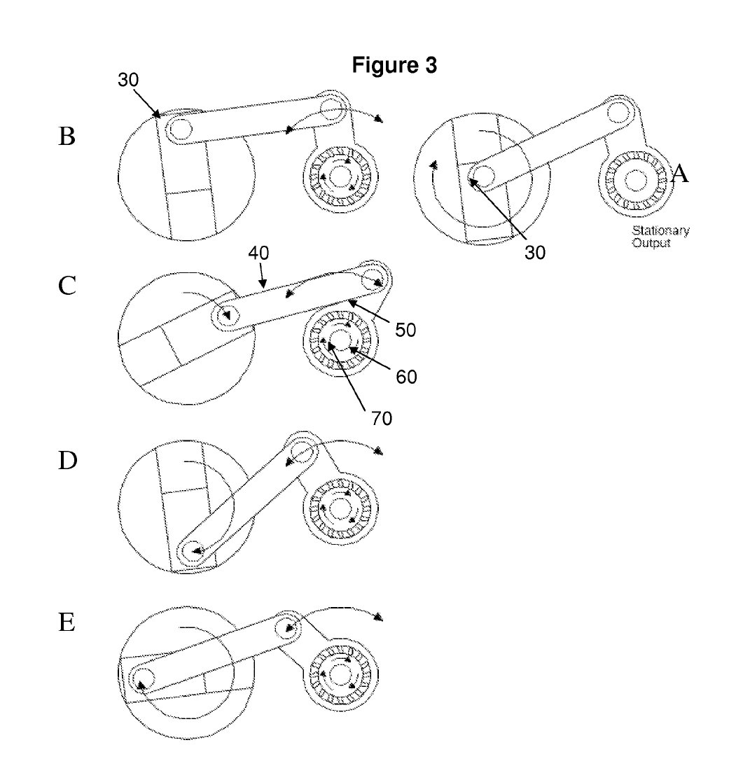

To convert this reciprocating motion to a smoothly turning rotary motion whose speed is proportional to the amplitude of the reciprocating motion, additional components that comprise an output element can be attached to the above-described mechanism. The first element of this output element is to attach the reciprocating end of the connecting rod 40 to a bell crank 50 (FIG. 3). The rotating axis of the bell crank is connected to a one-way clutch 60 (for example, a sprag or roller clutch) that only transmits, for example, the clockwise rotation of the bell crank to the output shaft upon which it is mounted. When the bell crank oscillates in the counterclockwise direction (for example), the one-way clutch slips and does not transmit the counterclockwise rotation to the output shaft. In FIG. 3A, the crank pin is located in the center of the input disk, so rotation of the input disk does not result in any movement of the connecting rod, the bell crank, or the output. In FIG. 3B, the crank pin is displaced from the center of the input disk. Rotation of the input disk in a clockwise direction (FIG. 3B-E) causes reciprocating motion of the connecting rod, which causes the bell crank to oscillate. In the illustrated example, the one-way clutch 60 transmits clockwise rotation to the output shaft 70, but does not transmit counter-clockwise motion due to slippage of the one-way clutch.

It is important to note that the fixed length bell crank should always be at least 20% longer than the maximum adjustment distance of the adjustable crank pin from the center of the input disk. If the distance of the crank pin from the center of the input disk were to approach the length of the output bell crank, the bell crank might cease the desired rotational oscillation and try to circle around one way or the other and jam the machine. If the crank pin were located a distance from the center of the input disk that is greater than the length of the bell crank, the input would jam on the first rotation. It is therefore necessary and desirable to limit the maximum distance of the crank pin from the center of the input disk to about 70% or 80% of the length of the bell crank to ensure proper operation.

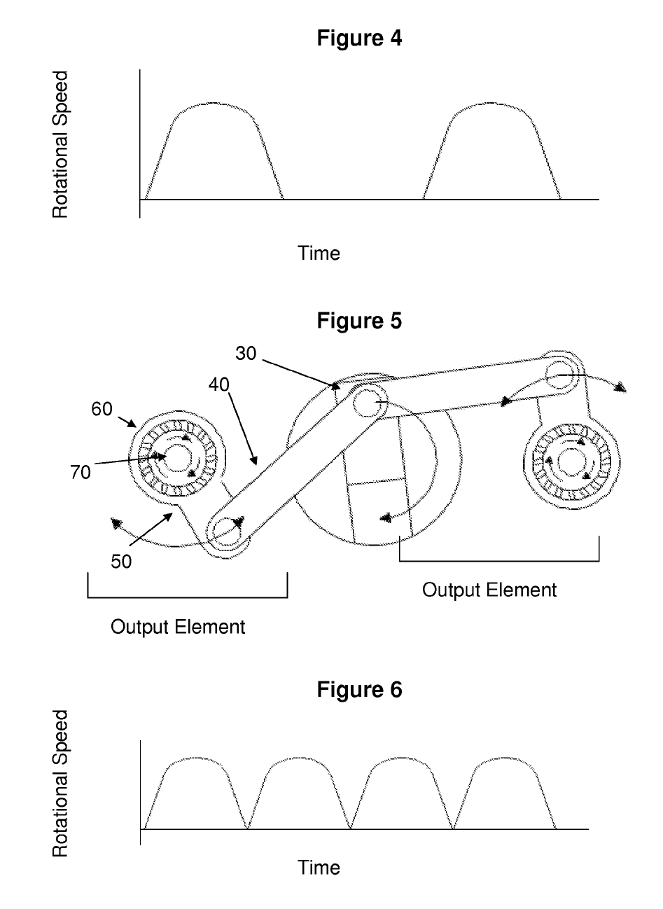

The device has now converted the reciprocating motion of the crankshaft to a rotary motion whose average rotational speed is proportional to the amplitude of the reciprocating motion. However, the output rotational speed is not smooth. Not only does the output speed vary over time, but also approximately 50% of the time (when the bell crank is reciprocating in the freewheel direction) the output shaft is not rotating at all. FIG. 4 shows an approximate output rotational speed versus time diagram.

In order to create a smoother rotational output, additional features can be added. The collection of parts consisting of the connecting rod 40, bell crank 50 and the one-way clutch 60 is defined herein as an “output element.” If one adds a second output element to the transmission, attached to the same crank pin 30 and rotated 180 degrees around the axis of the crankshaft opposite the first output element (FIG. 5). This second output element is identical in function to the first except that it operates 180 degrees out of phase with the first. If the outputs of both elements are then geared together in any convenient manner (chain and sprockets, gear train, toothed belt and sprockets, belt and pulley, etc.) each output element will then contribute output rotation during the stationary period of the other. The result is a much-improved output that while still having significant velocity variations eliminates the large periods of stationary output. The resulting output is graphically represented in FIG. 6. For a limited number of applications this design may be sufficient and acceptable.

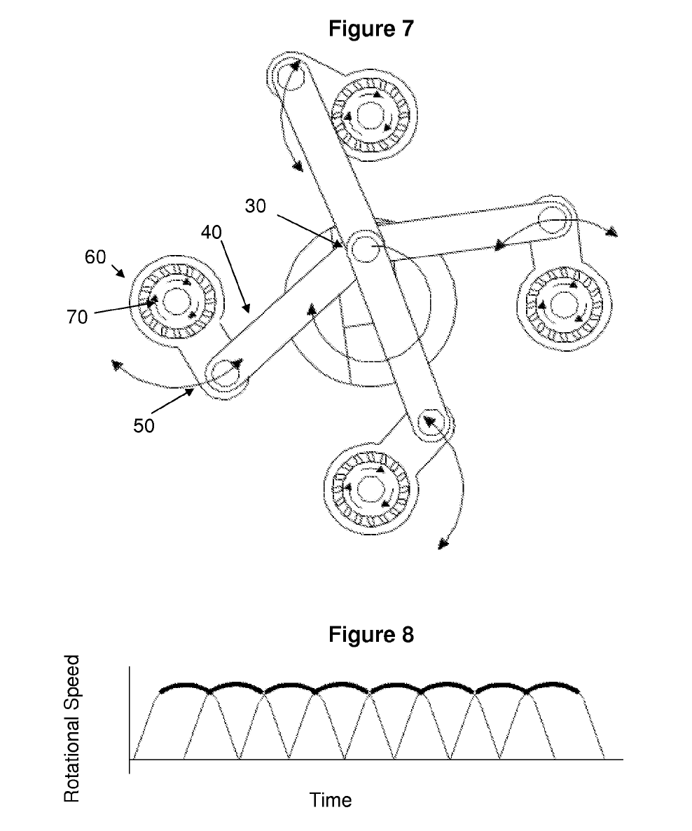

If more output smoothness is desirable, two more output elements can be added at 90 degrees and 270 degrees from the first two elements, as illustrated in FIG. 7. The graphical representation of the speed output of the four element transmission is shown in FIG. 8. Four output elements overlapping lead to a much higher level of output speed smoothness. For typical geometries, the amount of speed variation is less than 10%. Coupled with some type of output torsional dampening, (spring, friction, hydraulic, slipping clutch, etc.) a four element CVT of this design could be commercially acceptable for many applications, including automotive applications.

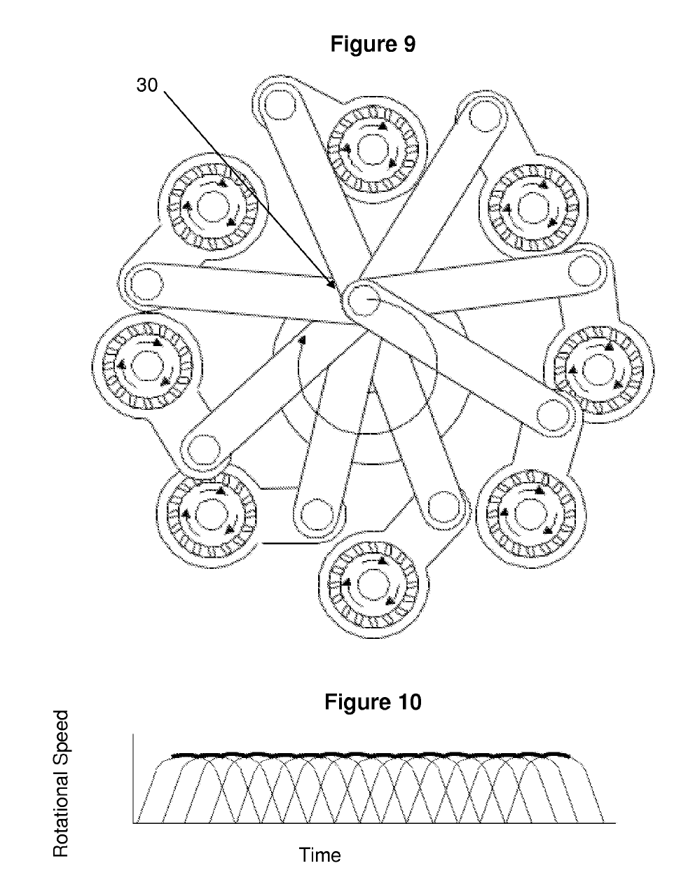

If a premium application requires a very high level of smoothness, an 8 element CVT can be implemented (FIG. 9). A rotational speed versus time plot for this design is shown in FIG. 10. With typical geometries, speed variations with this design can be reduced to about 2%. This should be sufficiently smooth for almost all applications. Outputs with more elements can be built to achieve even greater smoothness, but improvement is diminishing. Many elements can also increase the load capacity of the transmission as multiple elements begin to share the load in parallel.

It should be noted that speed variations in practice should be less than these theoretical numbers. The speed peaks will result in marginally higher loading than the valleys. Normal elastic deflections in all of the structural elements will provide built in torsional dampening. These deflections will be higher during the peak speeds—effectively slowing down the output slightly and smoothing the output more.

Also note that the progression of examples being 1, 2, 4, 8 elements is not a requirement. Any number of output elements including odd or prime numbers may be employed. Also, the spacing around the crankshaft need only be evenly spaced if a uniform output speed variation is desired. Practical design considerations may prove that deviations from even spacing may prove to be superior for the purpose of breaking up harmonic resonances in the transmissions structure.

### Alternative Hook Ups and Geometries of the Basic System

FIG. 9 shows one embodiment of the basic system having eight output elements. Other arrangements and geometries can be viable designs, which achieve different results.

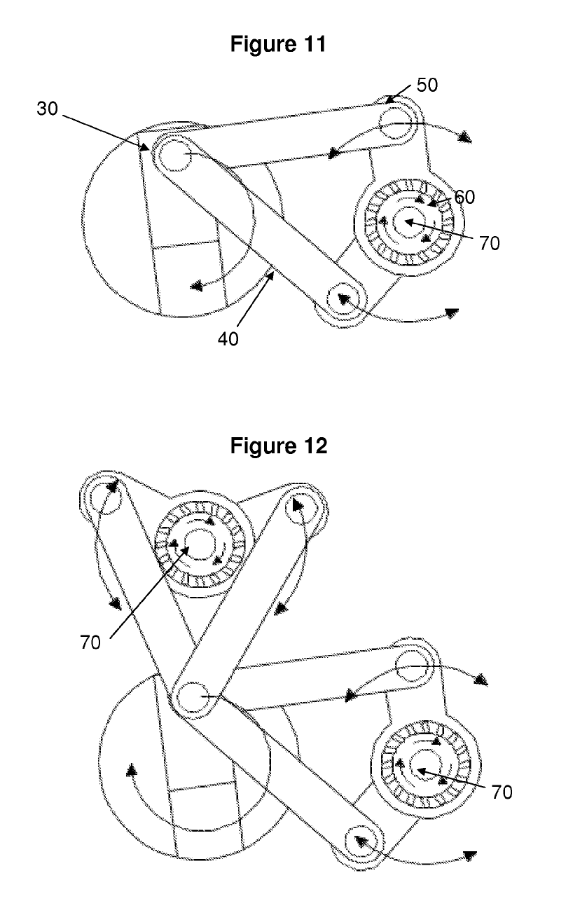

One area to economize on is the number of rotating axes. The system illustrated in FIG. 9 has nine—a large amount of complexity. FIGS. 11 and 12 show alternate versions of the two element and four element embodiments that are illustrated in FIGS. 5 and 7, respectively. This embodiment reduces the number of axes approximately in half. The elements that did reside 180 degrees out of phase on separate axes now reside on the same shaft, each with its own one-way clutch. If the connecting rods were infinitely long, these designs would be geometrically identical to those illustrated in FIGS. 5 and 7. But given the angularity of finite length connecting rods, these two bell cranks do not act on the output shaft exactly 180 degrees apart. The phase shift between bell crank speed contributions would alternate between slightly less than 180 degrees to slightly more than 180 degrees. This may not be detrimental for all applications and might even impart an advantage from a noise and vibration standpoint as discussed earlier.

This concept of pairing elements on common shafts can be extrapolated to an even greater number of elements than discussed so far. Any number can be incorporated as long as the elements are engineered to not interfere with one another in the final design package.

### Scotch Yoke Designs

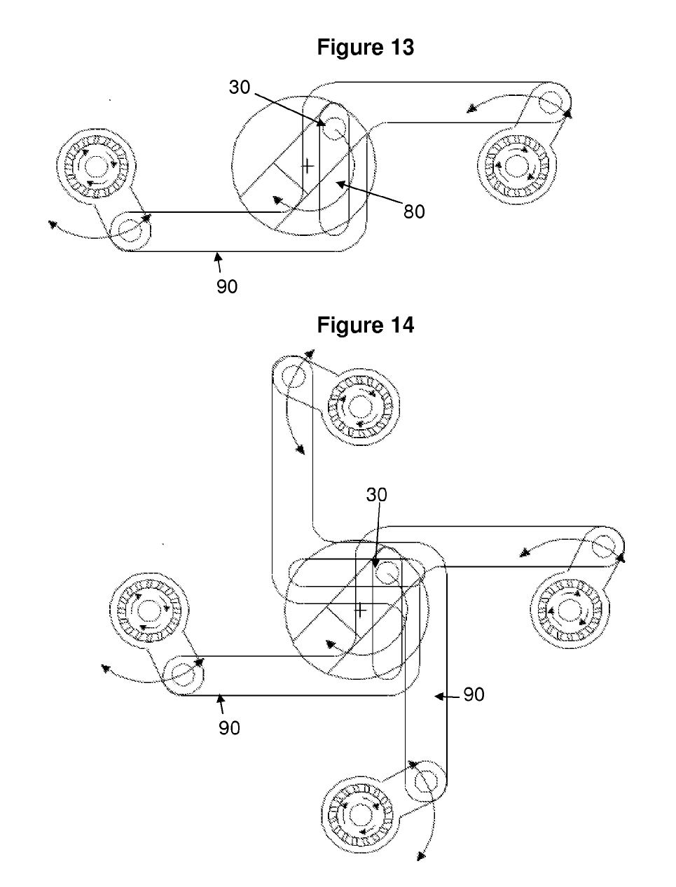

Instead of the adjustable crank pin driving the bell crank elements through a pivoting connecting rod, a whole family of designs can be created whereby the crank pin 30 drives the bell cranks via a slot 80 in a scotch yoke 90 (FIGS. 13 and 14). Although scotch yokes typically suffer from higher Hertzian stresses at the crank pin roller/slot interface this can be alleviated through the use of linear roller bearings in the slot.

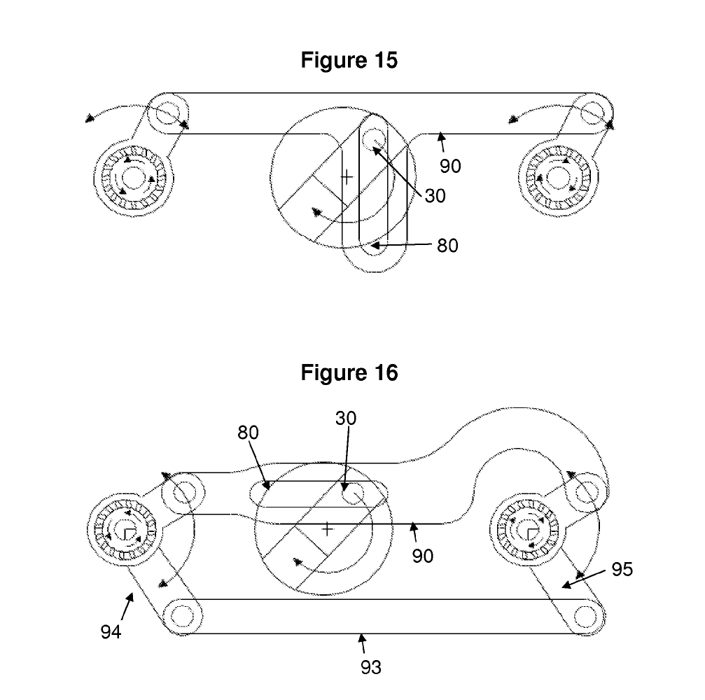

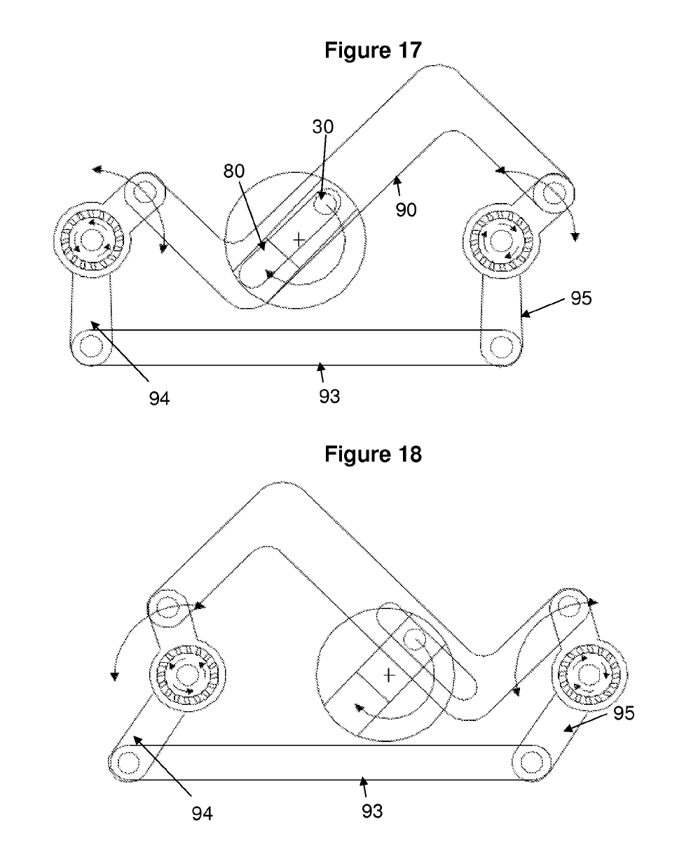

The main advantage of these concepts is better geometries with less translating errors. This is illustrated best in the three-axis design of FIGS. 15 to 18. In FIG. 15, one can see that the scotch yoke maintains its parallelism throughout its range of motion—leading to a minimal geometrical error (and least speed variations) relative to the other proposed designs. FIGS. 16 to 18 illustrate another major advantage of the scotch yoke. Unlike a connecting rod, it is not necessary to create a new axis rotated at a fixed angle to create a new element with a different phase output. All that is necessary is to rotate the slot in the scotch yoke and adjust the phasing of the output bell cranks. For example, in FIG. 15 the slot 80 is vertical, the slotted link reciprocates left to right and the power stroke occurs when the crankpin is in the vicinity of 12 o'clock and 6 o'clock. In the embodiment shown in FIG. 16, the slot 80 is horizontal, the slotted link transmits power by moving up and down, the bell cranks are rotated 90 degrees and the power stoke occurs when the crankpin passes through 3 o'clock and 9 o'clock. In this arrangement, the bell cranks must be rotationally synchronized by a secondary bell crank and link system that includes a secondary link 93 that connects a first secondary bell crank 94 and a second secondary bell crank 95. Without this synchronizing link, the slotted link would pivot around the crankpin during the power stroke and the opposite end would teeter-totter and push the opposite bell crank in the freewheel direction. The end result is that force could never be transmitted in the desired direction. By incorporating the synchronizing link system, the slotted link is forced to remain parallel during operation and power is effectively transmitted to the appropriate bell cranks. The same discussion pertains to the element systems shown in FIGS. 17 and 18 except there the slot and power stoke occur plus and minus 45 degrees from the vertical. The slotted links translate in a linear motion plus and minus 45 degrees from the vertical and the output bell cranks are indexed 45 degrees appropriately. A synchronizing link system is also necessary in both of these arrangements for the identical reasons stated for the system shown in FIG. 16.

If one were to stack up FIGS. 15-18 into one machine on a common crankshaft, an eight element CVT can be created with just two output axes. These two outputs rotate in opposite directions so appropriate measures must be taken when gearing them together. (See later section on output gearing options).

### Overdrive Version of CVT

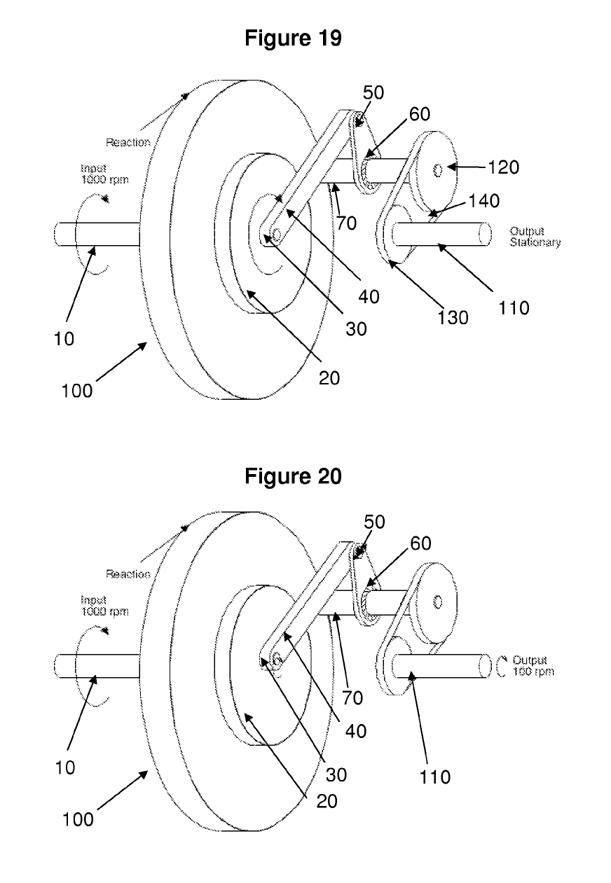

The theory of operation of the CVT has been described herein and is most easily understood as an underdrive transmission. That is, for a fixed input speed, say 1000 rpm, ratio changing can vary the output speed from 1000 rpm (1:1) to zero rpm (1:0). This is illustrated in the three dimensional diagrams featured in FIGS. 19-21. In these diagrams, only one output element is shown for simplicity.

FIG. 19 specifically shows the case with the crank pin 30 attached to the input disk 20 on the rotational axis of the rotating input shaft 10, so the crank pin spins freely inside the connecting rod 40 with no reciprocating action. The resulting output is therefore zero (1:0). In the embodiments shown in FIGS. 19 to 21, the main backing plate 100—to which all the output elements are mounted via bearings—serves as the main reaction member. This plate is grounded to the transmission's case and is always at zero speed. Optionally, the output shaft 70 can be connected to a driveshaft 110 by means of belts, chains and sprockets, gears, or other means known to those of skill in the art. In the illustrated embodiment, a first sprocket 120 drives a second sprocket 130 by means of a belt or chain 140. Gear trains or other mechanisms are also suitable for use in transmitting the rotation of the output shaft to the driveshaft 110.

FIG. 20 shows the transmission in which the crank pin adjusted slightly off of the center of the input disk 20, resulting in a 10 to 1 speed reduction (underdrive) (10:1). The connecting rod 40 moves back and forth, causing reciprocating clockwise and counterclockwise rotational movement of the bell crank 50, with the clockwise movement (in the illustrated example) being translated by the one-way clutch 60 into rotation of an output shaft 70. As in FIG. 19, a pair of sprockets and a chain or belt are illustrated driving a driveshaft 110.

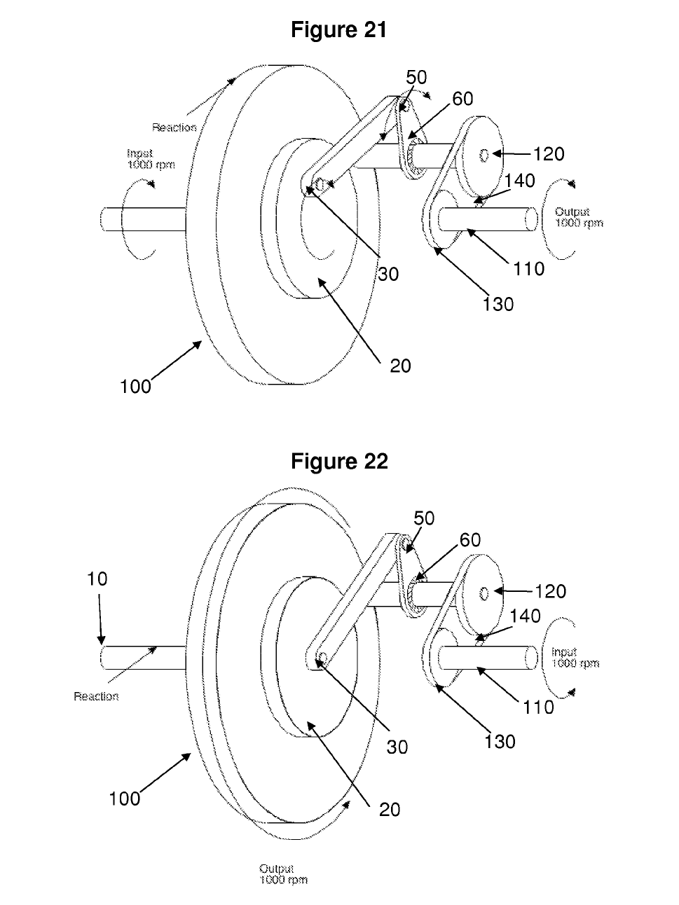

FIG. 21 is the 1:1 ratio case. Here the crank pin 30 is at its maximum design radius from the rotational axis of the input disk 20 (approximately 70% of the bell crank length). The sprockets 120 and 130 and associated chain or belt inverts the same ratio (1/0.70=143%) so that the resulting driveshaft 110 speed is the same as the input speed.

By switching the input, output and reaction elements, an overdrive version of the transmission can be created. This is best understood by comparing FIGS. 20 and 22. The transmissions are in the same configuration (crank pin 30 on axis of input disk 20) but they differ by reference frame. FIG. 22 shows a reference frame 100 rotating around the transmission at 1000 rpm. The net effect is to subtract 1000 rpm from the input shaft, the main support plate and the output shaft. What was the input shaft 10 in FIG. 20 is now at zero speed and becomes the new reaction member. What was the output (driveshaft) 110 in FIG. 20 is the new input member and is now rotating counterclockwise at 1000 rpm. What was the reaction plate 100 is now the output and is rotating counter clockwise at 1000 rpm. So in the new overdrive configuration, this is the 1:1 ratio case.

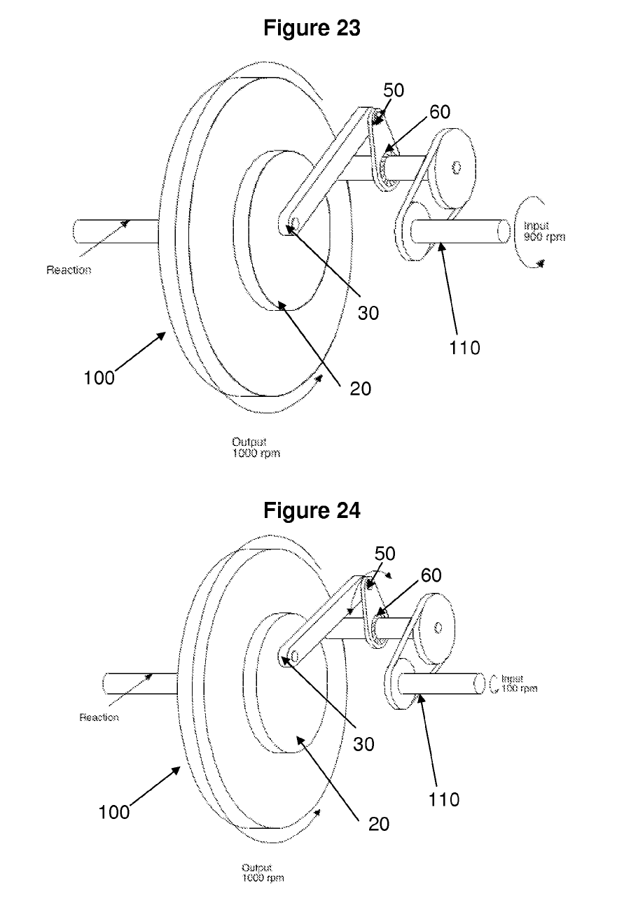

In FIG. 23, the crank pin 30 is adjusted slightly off of center of the input disk 20. This results in a slight overdrive. With the new input 110 rotating at 900 rpm, the new output 100 is turning at a 1000 rpm. If the input 110 were accelerated to 1000 rpm, the output would spin at 1000/900×1000=1111 rpm.

In FIG. 24, the crank pin 30 is adjusted further out from the rotational axis of the input disk and the transmission now has a 10× overdrive ratio. With an input 110 speed of 100 rpm, the output 100 spins at 1000 rpm. Likewise, if we were to spin the input 110 at 1000 rpm, the output 100 would spin at 10,000 rpm. As the crank pin 30 is adjusted further out, the output will theoretically attempt to achieve infinite speed. This cannot be achieved in practice, as friction will cause the input member to lock up at some finite ratio. However, quite large finite overdrive ratios should be practical. This configuration would result in a device that is uniquely capable of accelerating a flywheel by purely mechanical means for the purpose of energy storage.

Overdrive CVT with Reversing Capability

With a slight modification, the overdrive configuration can be employed to give useful reverse gear functionality for certain transmission configurations.

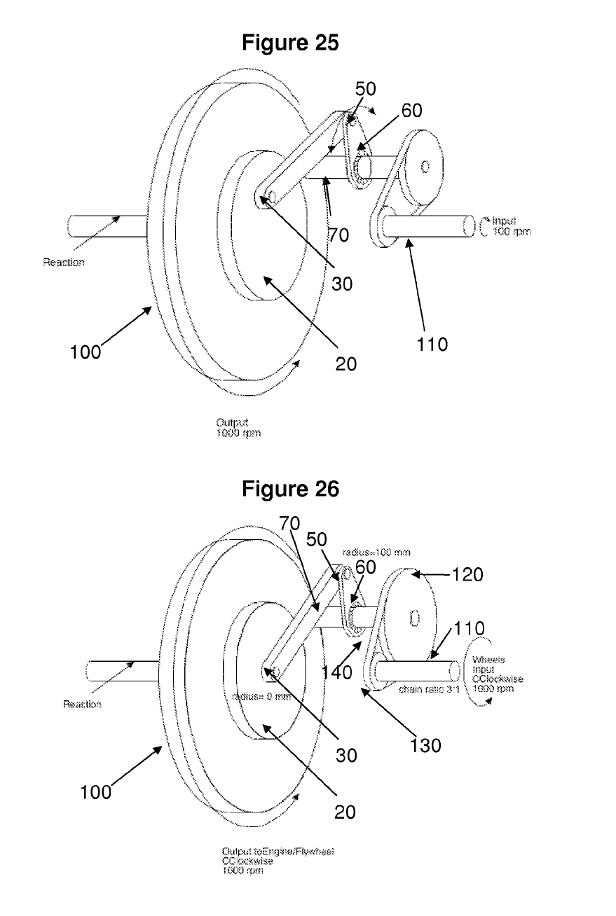

FIG. 25 illustrates the overdrive CVT configuration but with a greater step up in the output gearing than what is necessary to compensate for the maximum lever ratios of the crank pin/bell crank. In the illustrated example, this output ratio is a 1:2 step up in speed. When the distance of the crank pin 30 from the rotational axis of the input disk 20 (this distance is termed the “crank pin radius” herein) reaches one half the radius of the fixed bell crank (the distance between the rotational axis of the output shaft 70 and the center of the attachment point of the connecting rod to the bell crank; this distance is termed the “bell crank radius” herein), the transmission has reached the theoretical infinite speed overdrive. The transmission should only pass through this point with the output not turning or declutched from the driveline.

If the crank pin is adjusted to a radius greater than 50% of the bell crank radius—say to the maximum design radius of 70%- and the input and outputs are reversed, the transmission will reverse output rotation. Specifically, if one drives the support plate 100 in the same direction (as shown), the geared output will rotate in the opposite direction with a speed reduction. In this case with 1000 rpm on the support plate 100, the result would be a 400 rpm reverse rotation on the output gearing.

Exploiting this ability to reverse in a practical automotive transmission design is discussed below.

### Combination Overdrive/Underdrive CVT

If the step up in the output gearing is changed to 1:3, the transmission still operates as an overdrive transmission as before. However this time it reaches the theoretical infinite overdrive point when the crank pin radius reaches one third of fixed bell crank radius. Moving beyond that radius, the output reverses, as in the prior configuration. And like before, the output rotates at an underdrive ratio with the main support plate driven as an input relative to the output. Right at the one-third crank pin radius point the underdrive is infinite from the main support plate to the output (1:0). That is, the main support plate 100 as the input can be freely rotated with no transfer of rotation to the output. As the crank pin radius is made slightly greater than one third of the fixed bell crank radius, the output will start to turn slowly relative to the main support plate input with a maximum underdrive reduction. As the crank pin radius increases out to two thirds of the bell crank radius, the underdrive ratio increases up to 1:1.

FIGS. 26-32 illustrate various speed settings of both overdrive and underdrive modes. In the embodiment shown in FIG. 26, wheels drive the driveshaft 110 counter-clockwise at 1000 rpm. A pair of sprockets 120 and 130 and a chain 140 drive the output shaft 70 at a 1:3 ratio. With the crank pin radius set at zero mm from the rotational axis of the input disk and the bell crank radius at 100 mm, the output to the engine/flywheel 100 is the same as the input (1000 rpm counterclockwise).

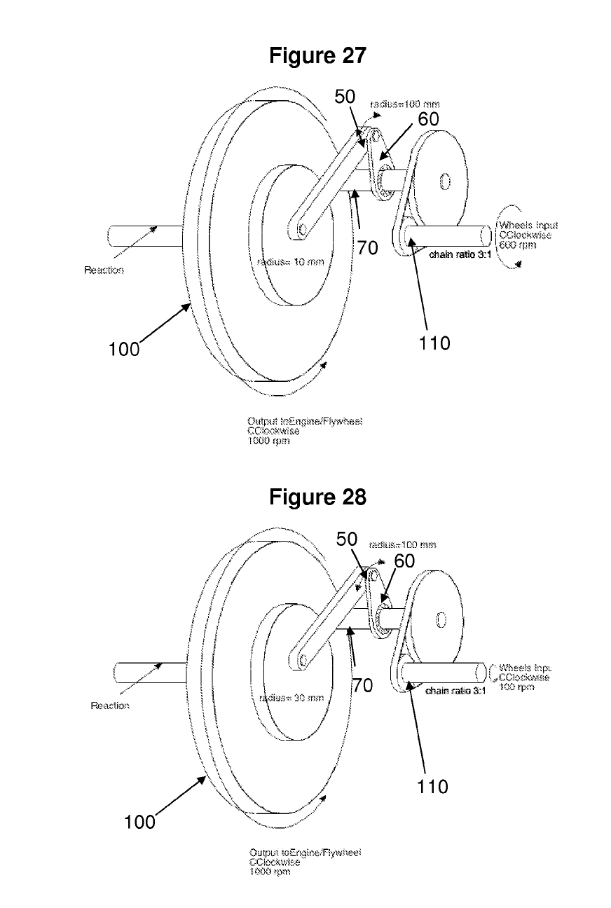

In FIG. 27, the input is reduced to 600 rpm counterclockwise. But by setting the crank pin radius at 10 mm, the output 100 remains at 1000 rpm counterclockwise. In FIG. 28, the input is reduced still further, to 100 rpm counterclockwise. By moving the crank pin to 30 mm from the rotational center of the input disk, the output is maintained at 1000 rpm counterclockwise.

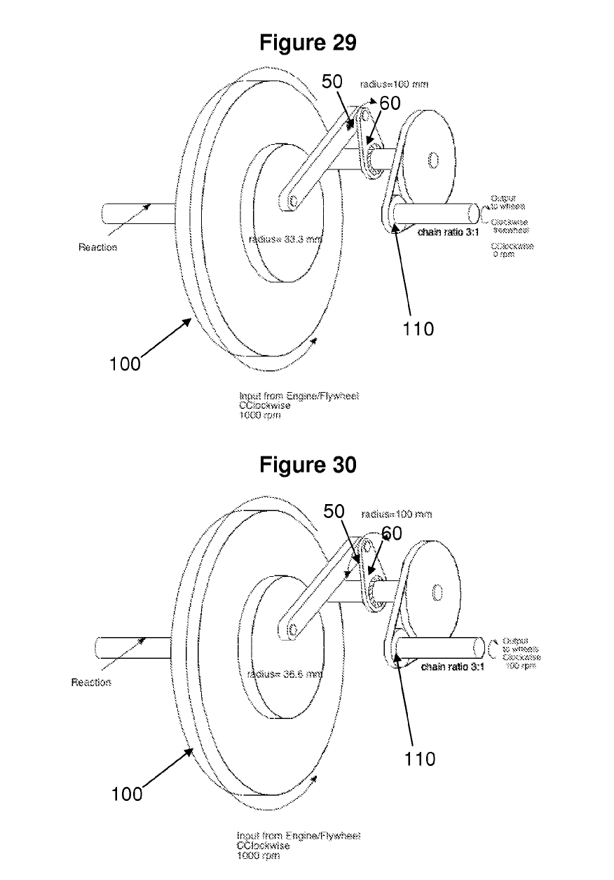

FIG. 29 shows the transmission with the crank pin radius set at one third the bell crank radius. Now, the input force (1000 rpm counterclockwise) is applied from the engine/flywheel to the main backing plate 100. The chain ratio is set at 3:1, thereby reducing the output to the driveshaft 110 to zero.

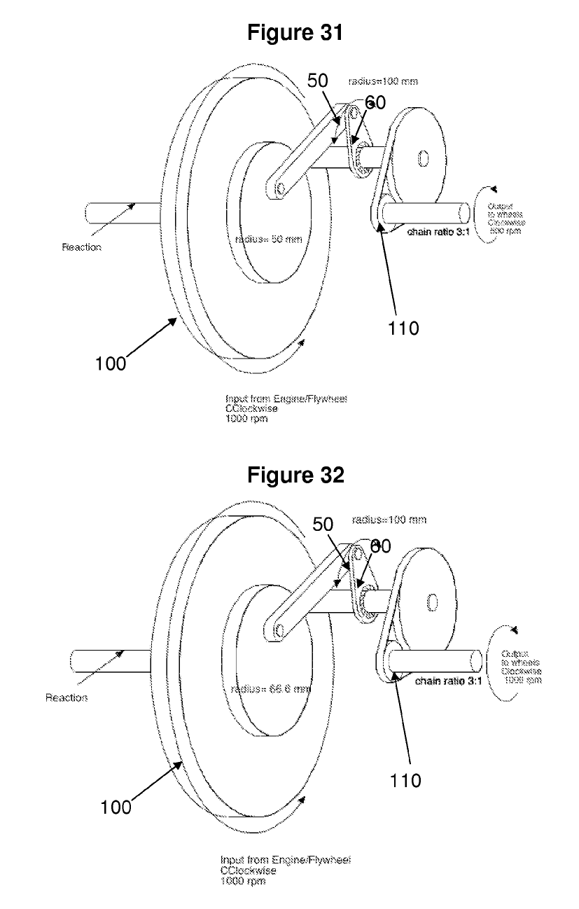

When the crank pin radius is increased beyond one-third of the bell crank distance as shown in FIG. 30, the transmission converts the 1000 rpm counterclockwise input to a 100 rpm clockwise (the opposite direction of the input) output at the driveshaft 110. A further increase in the crank pin radius, as illustrated in FIG. 31, results in a 1000 rpm counterclockwise input being converted to a 500 rpm clockwise output at the driveshaft 110. Increasing the crank pin radius to two-thirds the bell crank radius as shown in FIG. 32 results in the 1000 rpm counterclockwise input being reversed to a 1000 rpm clockwise output at the driveshaft 110.

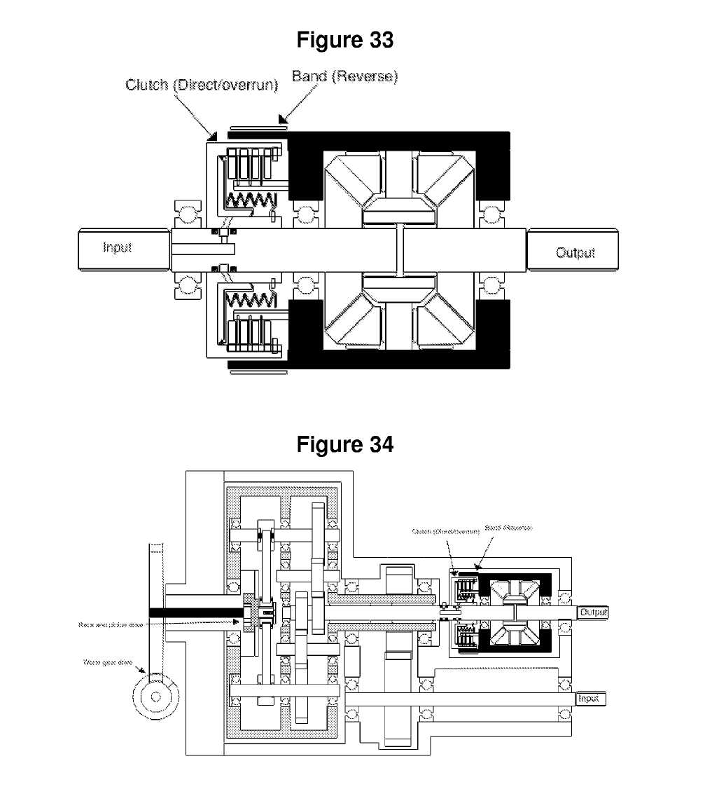

A CVT configured as described above can therefore cover a theoretically infinite ratio range from underdrive to overdrive—the only drawback being the reversal of output direction as the CVT transitions from overdrive to underdrive modes. If a forward/reverse shifting gear unit is connected to the output of this transmission (FIGS. 33 and 34) and it is reversed as the transmission transitions from overdrive to underdrive mode, the transmission can perform both overdrive and underdrive duties with the reversing output being negated by the add on reversing mechanism. With the output of the reversing gear unit connected to the drive wheels of a vehicle, and the main support plate connected rotate-ably to an energy storage flywheel, this configuration can serve both overdrive and underdrive functions for a vehicular flywheel energy storage system. This system is discussed in greater detail below.

Underdrive CVT with Bi-Directional Torque Carrying Capability

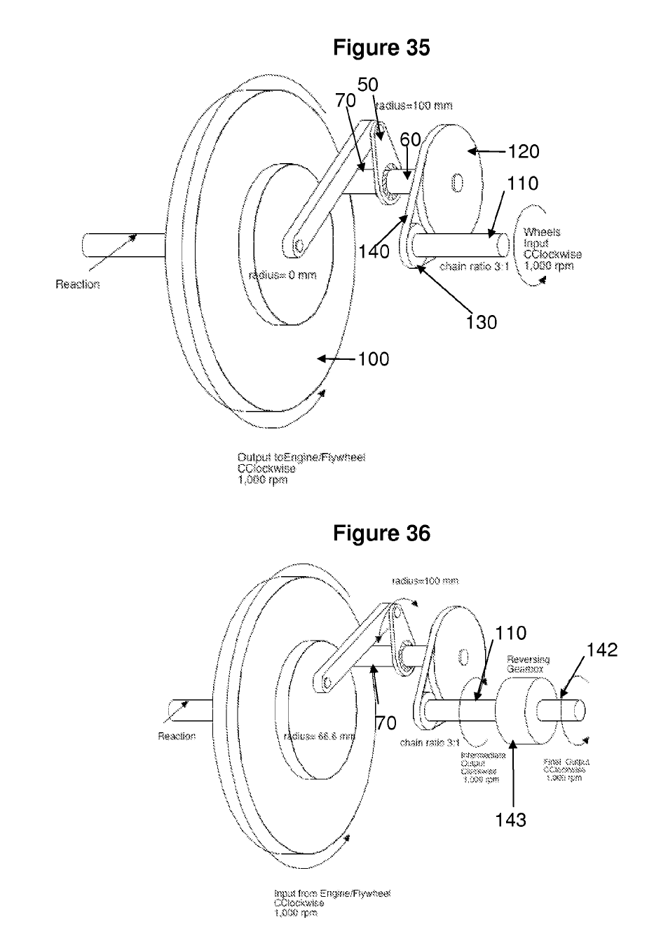

Two versions of the above transmissions can be created and designed into a single transmission machine to create a wide ratio underdrive transmission that can carry torque in both directions. FIG. 35 shows a transmission with the crank pin radius (distance of crank pin 30 from rotational center of input disk 20) set at zero mm, the bell crank radius is 100 mm and the final drive ratio set at 3:1. An input force of 1000 rpm counterclockwise is applied to the driveshaft 110 (e.g., by the wheels of a car). The chain and sprockets reduce this by 3:1 in this example, and the output to the engine/flywheel is also 1000 rpm counterclockwise. In FIG. 36), the crank pin radius of the transmission is set at 66.6 mm (two-thirds the bell crank radius, which is again 100 mm). Now, the input force is applied to the main backing plate 100 (for example, by the engine or flywheel of a car). In the illustration, the input force applied by the engine or flywheel is 1000 rpm counterclockwise, resulting in a clockwise rotation of the output shaft 70. The chain and sprockets step up the rotation of the driveshaft 110 to 1000 rpm, but still a clockwise direction. To compensate for the reversal in direction, a reversing gearbox 143 is employed. In the illustrated example, the reversing gearbox has a 1:1 drive ratio, resulting in the output at the final drive shaft 142 being 1000 rpm counterclockwise. Thus, the transmission can transmit torque in either direction—from the engine/flywheel to the wheels, or from the wheels to the engine/flywheel.

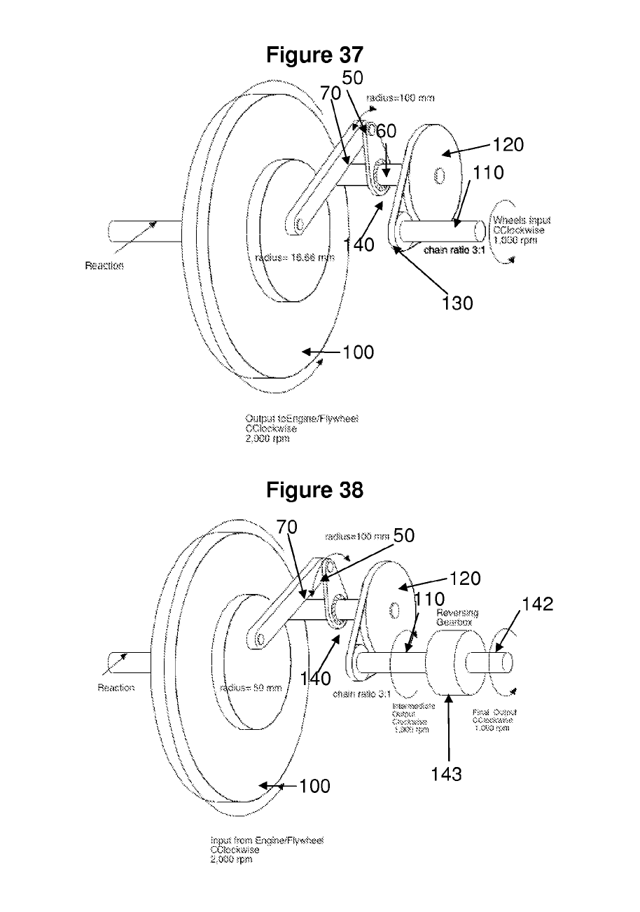

FIGS. 37 and 38 show a continuously variable transmission with its crank pin radii at 16.6 mm and 50 mm, respectively. The bell crank radius is 100 mm, and the chain ratio is 3:1. In the example shown in FIG. 37, torque is transmitted from the wheels (input at the drive shaft 110 is 1000 rpm counterclockwise) through the sprockets and chain to the output shaft 70. With the crank pin radius set at less than one third the bell crank radius, the one-way clutch transmits a counter-clockwise rotation of 2000 rpm to the main backing plate 100. In the example shown in FIG. 38, the input force is applied to the main backing plate 100 (e.g., by an engine or flywheel of a car) instead of to the driveshaft as in FIG. 37. A 2000 rpm counterclockwise input results in a clockwise rotation of the output shaft 70. The 3:1 ratio provided by the chain and sprockets step the output up to 1000 rpm clockwise at the driveshaft 110. To convert the output to a counterclockwise rotation at the final drive shaft 142, a reversing gearbox 143 is employed.

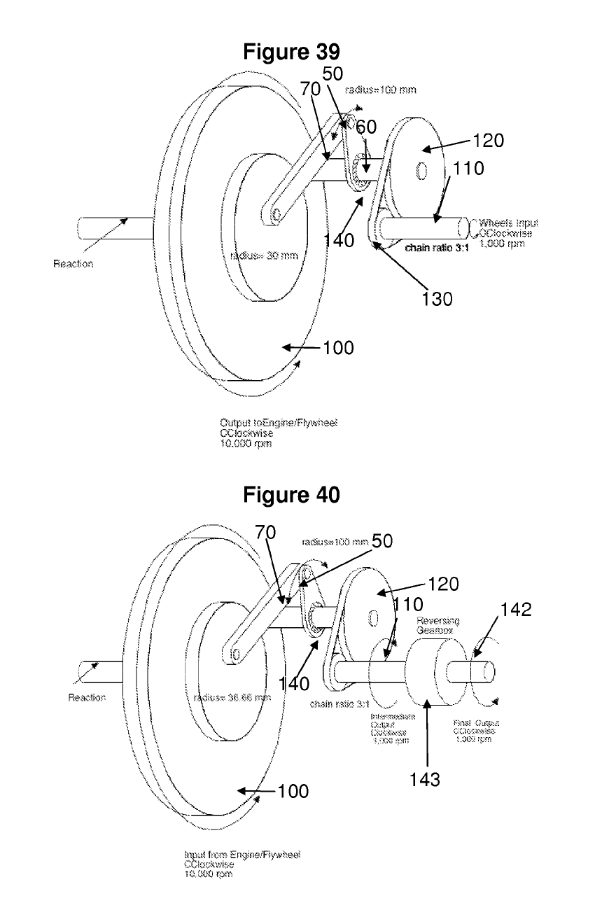

FIGS. 39 and 40 again show the continuously variable transmission, this time with their crank pin radii at 30 mm and 36.6 mm, respectively, and a bell crank radius of 100 mm in each case. The transmissions provide a 10:1 reduction with torque transmitted in both directions (in FIG. 39, torque is transmitted from the driveshaft 110 to the main backing plate 100 (e.g., to the engine/flywheel), while in FIG. 40, torque is transmitted from the main backing plate to the driveshaft). In FIG. 39, a 1,000 rpm counterclockwise input results at the driveshaft results in a 10,000 rpm counterclockwise output at the main backing plate 100. In FIG. 40, a 10,000 rpm counterclockwise input at the main backing plate results in a final output of 1000 rpm counterclockwise (through the reversing gearbox 143 that is attached to the transmission).

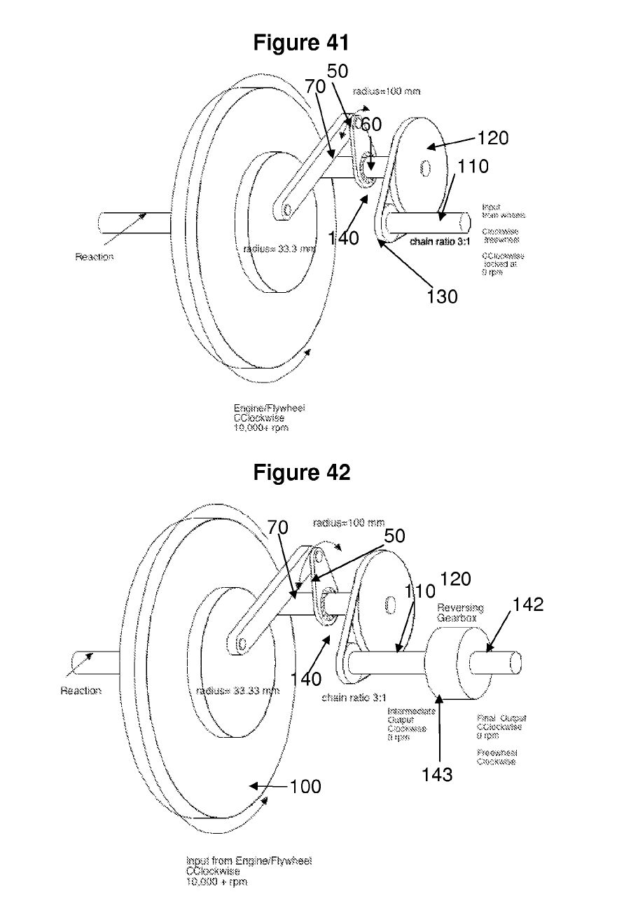

When both crank pins converge at 33.3 mm (one third the bell crank radius) (FIGS. 41 and 42), both transmissions have achieved 0:1 speed ratio. The engine/flywheel is free to spin at any speed without transmitting any torque and the wheels are locked, unable to transmit torque in either direction.

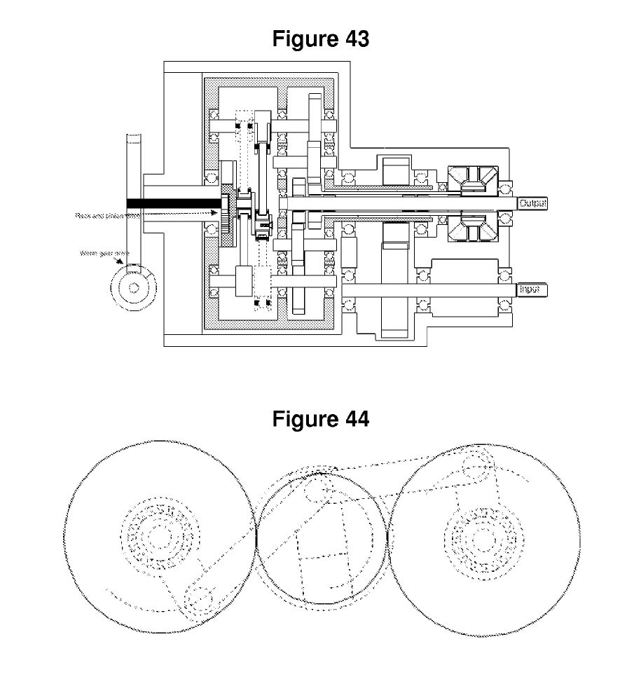

These two transmissions (one with a reversing gearbox and one without) can be mechanically blended together into a single machine where they share a common input, reaction (crank pin moving mechanism) and output. An example of one such embodiment is shown in FIG. 43. Two independent sets of bell cranks and output gear systems are combined into a single rotatable assembly (input). The two systems are attached to separate crank pins, which are in turn attached to a common sliding mechanism (reaction). The two crank pins are permanently spaced 66.6 mm apart. The sliding mechanism's range of motion is from a point where one crank pin is at the center of the machine with the other is 66.6 mm off center, to a point where both crank pins are 33.3 mm offset on opposite sides of the center. The two output gear systems transmit motion through separate, coaxial shafts. (One solid shaft, one hollow shaft) The hollow shaft enters the input of the reversing gearset and the solid shaft passes through the reversing gearset and is permanently (without a clutching mechanism) and rotatably connected to the output of the reversing gearset (Output).

### Output Gearing Options

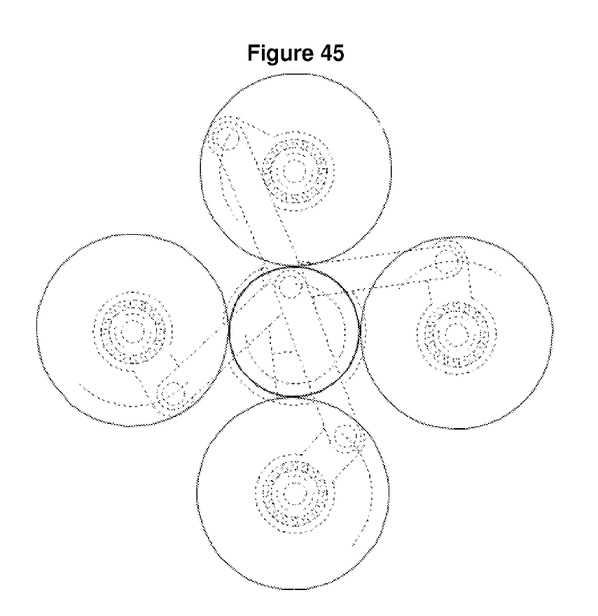

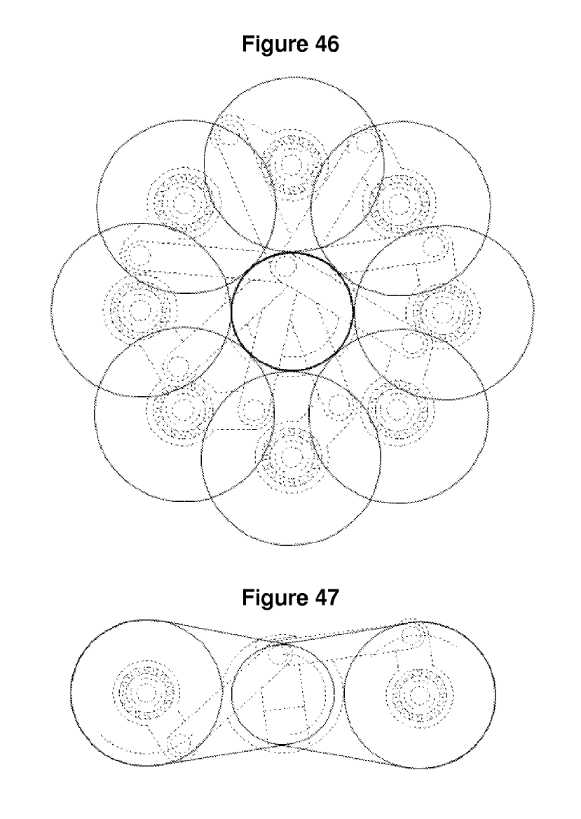

In typical versions of CVT of the invention, the various numbers of output elements are geared positively together in a rotational sense. This can be accomplished with chains and sprockets, gears, toothed belts, etc., or any other positive type of drive mechanism. FIGS. 44 and 45 show a gear type drive system with a typical overdrive CVT to achieve a net 1:1 top ratio. Two output element (FIG. 44) and four output element (FIG. 45) embodiments are shown. For simplicity, the pitch diameters of meshing gears is represented by the circles drawn concentric with each axis. Where the circles touch tangentially is where two gears mesh with each other. FIG. 46 illustrates an eight-element version. In each of these arrangements, all of the bell crank/freewheeler elements can transmit rotational power to the center output shaft. The overdrive output ratio with eight elements as shown in FIG. 46 has drive gears so large and close together that they overlap each other. This can be mechanized by incorporating two rows of gearing so that the drive gears alternate axially with each other. These two staggered rows of four drive gears then mesh with two stacked driven gears on the common output shaft 70. All of these embodiments reverse the output direction from the input.

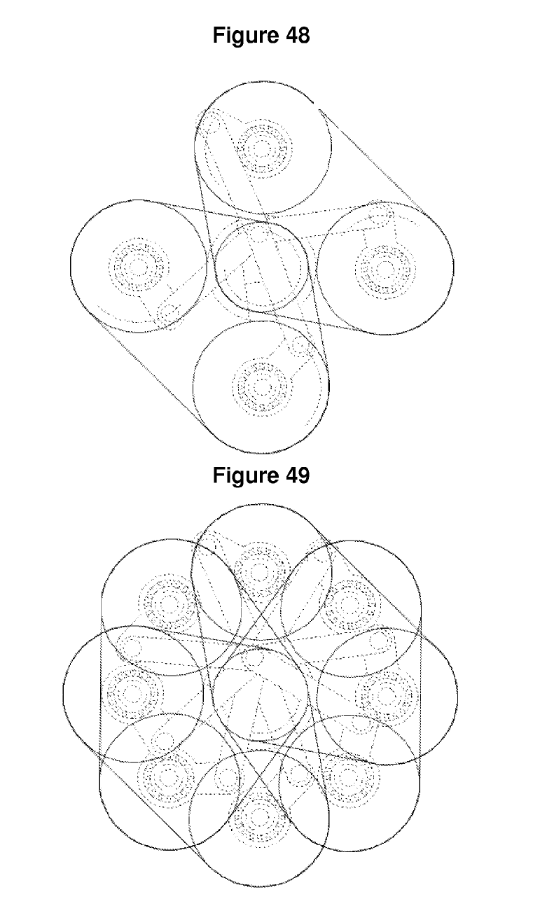

FIGS. 47 to 49 show chain and sprocket arrangements. Again, for simplicity lines tangentially intersecting circles represent the chains. The circles represent the pitch diameters of the sprockets. Chains require a certain amount of sprocket wrap angle so all versions require multiple, staggered output sprockets. Anywhere chains have to cross one another would require a new row of sprockets axially offset along the respective shaft to clear the other chain. Two and four axis arrangements (FIGS. 47, 48) require two staggered rows of sprockets while the eight axis arrangement (FIG. 48) requires four staggered rows of sprockets. Chains do not reverse direction.

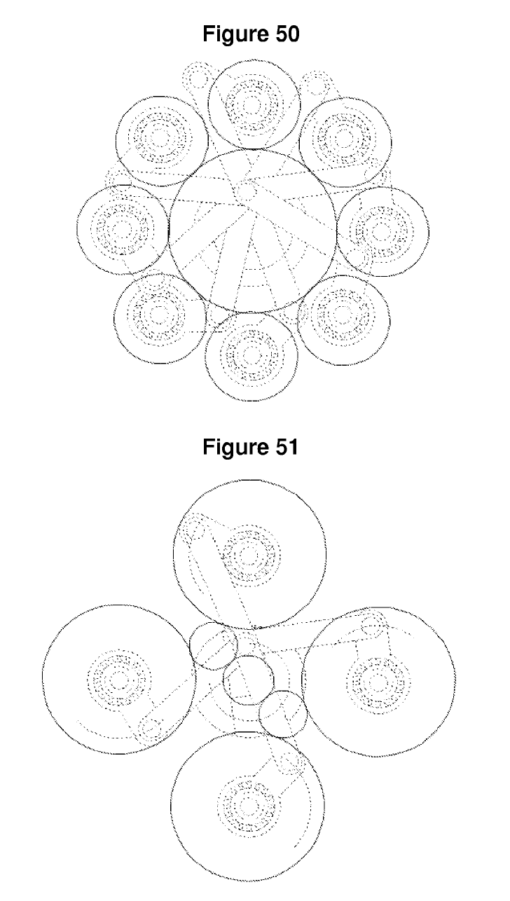

If a reverse direction and a net underdrive output are acceptable, a greatly simplified output gear system can be employed as shown in FIG. 50. Using a large driven gear and small driven gears permit the whole gear train to be package on a single plane of gears.

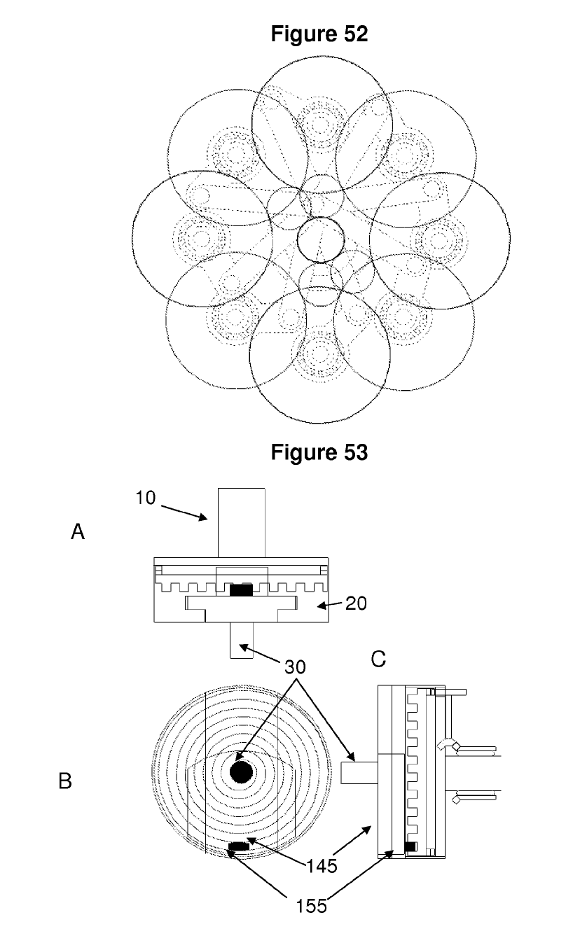

If reverse rotation is not acceptable and a premium gear drive with a large output overdrive (1:3) is needed, then an intermediate idler gear can be employed to mesh two outer gears and reach a small final driven gear. FIGS. 51 and 52 show four- and eight-output element embodiments respectively.

### Design Examples for Certain Aspects of the CVT

Moveable Crank Pin on Input Crankshaft

In some embodiments, for example as shown in FIG. 1, the crank pin 30 is mounted onto a flat plate 145 that engages slots in the face of the input disk 20. The crank pin is mounted on one end of the plate 145 so that that at one end of its sliding range, the crank pin lies in line with the rotational axis of the input crankshaft (FIG. 1A). At the other extreme of its travel, the crank pin is at its maximum design radius (FIG. 1B). The crank pin/plate assembly could also include a threaded hole along its sliding axis and could be moved through its range of motion by, for example, rotating a threaded rod, mounted inside the disk with a bearing at one or both ends.

Alternatively, the same crank pin sliding plate assembly 145 could be designed with a protruding dog element 155 in its underside instead of a threaded hole (FIG. 53). This protruding dog would engage a spiral wheel that can be rotated on the same axis as the input shaft. As the spiral wheel rotates the dog on the crank pin assembly would move in a radial direction, moving the sliding crank pin assembly through its full range of motion.

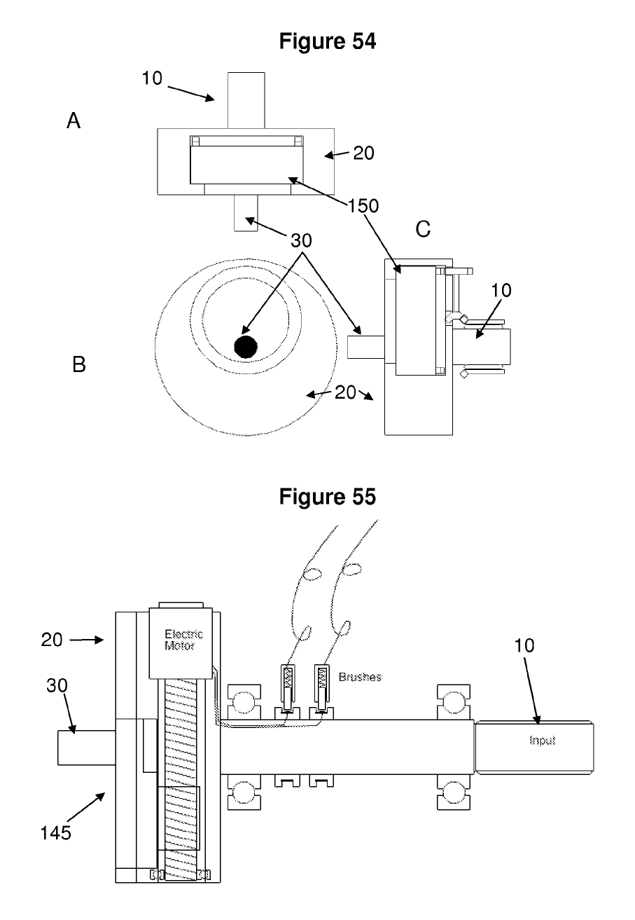

Alternatively, the crank pin 30 could be mounted in an offset from center location on a rotatably moveable disk 150 (FIG. 54). This disk would be smaller than and embedded in an offset position on the input disk 20. As this crank pin disk 150 is adjustably rotated through 180 degrees, the crank pin can be positioned from the center of the input crankshaft 10 to the designed maximum radius or anywhere in between. An external gear on the back of the crank pin disk can engage an adjusting spur gear for positioning. (See adjustment mechanisms discussion below).

Crank pin adjustment in the stationary reference frame

In some of the embodiments of the movable crank pin mechanisms, the mechanisms reside on the input crankshaft, which is typically rotating at high speed. The crank pin position needs to be adjusted in a controlled manner to a defined position independent of the input system's rotating conditions.

In one embodiment, an electric motor of any type (servo, stepper, DC, AC induction, etc.) is mounted on the input crankshaft 10 and is rotatably connected to the adjustment mechanism by means well known to those skilled in the art (e.g., gears, chain and sprockets, couplers, etc.) The electrical connections to this motor would be transferred to the stationary reference frame via electrical slip rings and brushes (FIG. 55).

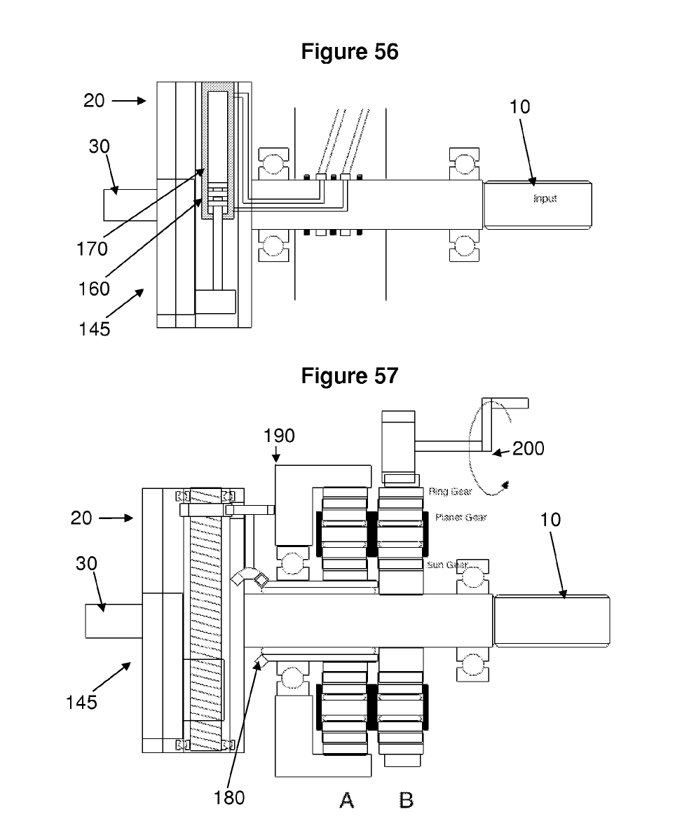

In another embodiment, the sliding crank pin 145 adjustment is positioned via a hydraulic actuator consisting of a piston 160 and cylinder 170 (FIG. 56). This double acting actuator is moved by high-pressure hydraulic fluid pressure that communicates with the stationary reference frame via rotating hydraulic seal rings. These seals are well known art in hydraulic system design.

There may be applications where the prime mover assigned to adjust the ratio of the CVT cannot be limited to devices with power and control connections that are readily adaptable to translation through a rotating reference frame. For these applications, purely mechanical motion translation devices are provided. One such device is shown in FIG. 57. Here, the adjustment mechanism is geared via a set of spur gears, radial shaft and spiral bevel gears to an adjustment sleeve 180 supported by a needle bearing coaxial with the input shaft 10. When this sleeve is rotated relative to the input shaft, the crank pin adjustment mechanism 145 responds.

Translating the relative rotation of this sleeve from the rotating to stationary reference frames is accomplished through the novel connection of two identically ratioed planetary gear sets (FIG. 57, indicated by A and B). The connections of these planetary gear sets is as follows:

Sun Gear A—Adjustment Sleeve 180

Ring Gear A—Case Ground 190

Sun Gear B—Input Shaft 10

Ring Gear B—External Adjustment Mechanism 200

Planet Carrier A—Planet Carrier B

It can be seen that if ring gear B is held stationary like ring gear A, all elements of each gear set will turn at the same speeds as the other gear set. Another way to say this is since sun gear B is connected to the input shaft, both planet carriers are tied together and both ring gears are stationary therefore sun gear A and the adjustment sleeve will also turn precisely at the same speed as sun gear B and the input shaft. Since there is no relative motion between the input shaft and the adjustment sleeve—no change in the crank pin offset will occur.

Now take the case where the input shaft is stationary. If ring gear B is turned, planet carrier B will also turn somewhat slower depending on the ratio of the sum of the ring and sun gears number of teeth divided by the number of ring gear teeth (S+R)/R. Planet carrier A will turn in concert with planet carrier B. Since ring gear A is always grounded, sun gear A (and the adjustment sleeve) will turn somewhat faster with a ratio to the planet carriers depending on the number of teeth of the sun gear divided by the sum of the number of teeth of the sun gear and ring gear S/(S+R). The net result of this is the adjustment sleeve will turn with a relative ratio to ring gear B depending on the number of teeth of the sun gears divided by the number of teeth of the ring gears (S+R)/R×S/(S+R)=S/R.

The crank pin offset can therefore be adjusted by turning ring gear B relative to the stationary reference frame. This can be accomplished independently of the rotational speed of the input crankshaft.

Attachment of Multiple Connecting Rods to a Single Crank Pin

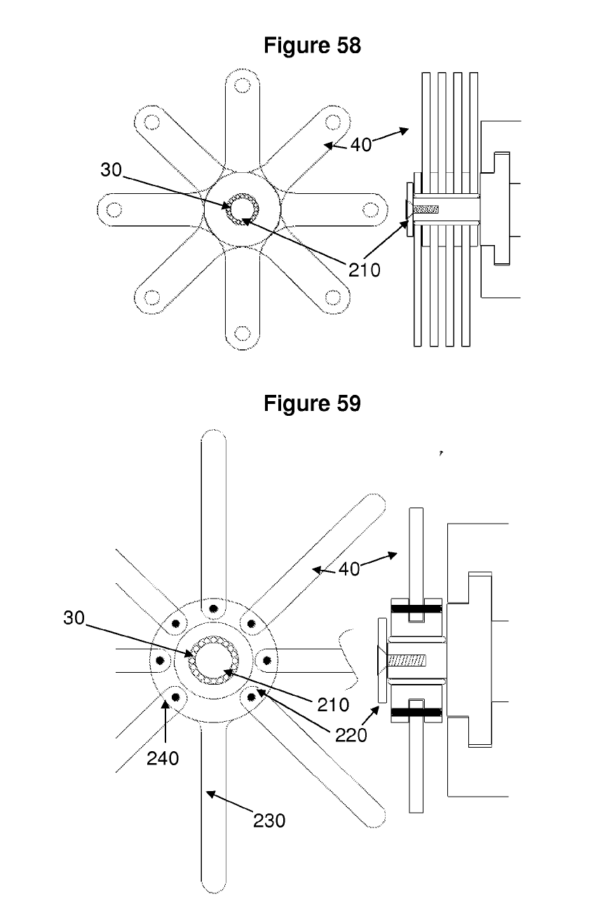

A continuously variable transmission of the present invention can have multiple connecting rods attached to a single crank pin. A basic embodiment is shown in FIG. 58. Here, eight very thin but broad connecting rods 40 are simply stacked up next to one another on a single needle roller bearing 210. It should be noted that it is generally desirable to keep the length of the crank pin as short as possible to minimize the amount of cantilevered load and consequent deflection on the crank pin. In the ideal situation, a separate needle bearing should support each connecting rod. This is due to the fact that the connecting rods undergo a slight rotational displacement relative to one another during operation. Implementing a separate needle bearing for each connecting rod would force the crank pin to be excessively long. With a single needle bearing supporting all of the connecting rods some slight skidding of the rollers will occur, but since typically only one of the connecting rods is heavily loaded at a time, any skidding will occur on unloaded connecting rods and should not cause a problem with excessive wear.

Another particular embodiment of the crank pin attachment is shown in FIG. 59. Here a short intermediate hub 220 supported by a single needle bearing 210 is mounted on the crank pin 30 and can freely rotate. One connecting rod 230 is rigidly attached to the hub. The remaining connecting rods 40 are connected to the perimeter of the hub via freely swiveling pin connections 240. This way, each connecting rod can freely move in their required slight angular swiveling relative to one another, while the major rotational motion is borne by the single needle bearing and hub assembly.

Dedicated Over-Run/Reversing Mechanism

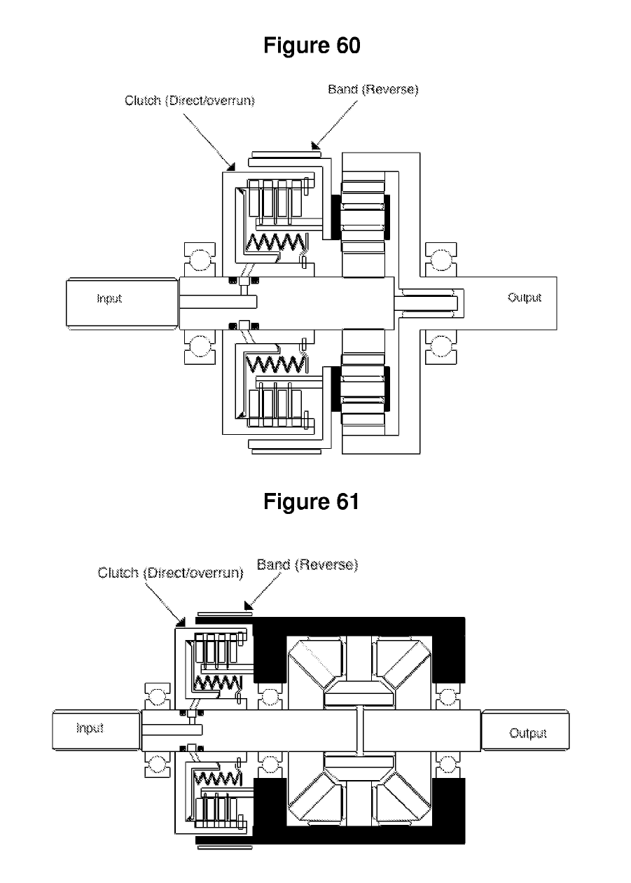

One embodiment of an over-run/reversing mechanism is shown in FIG. 60. This mechanism is suitable for use in, for example, the transmission shown as 143 in FIG. 36. The mechanism consists of a single planetary gear set, a rotating clutch and one stationary band clutch. The two clutches can be hydraulically operated as is typical in automatic transmission design, although other mechanisms for operating clutches as are known in the art are also suitable. The input from the engine, in addition to driving the input of the CVT, is connected in parallel to the sun gear of the planetary gear set. The output of the CVT is connected in parallel to the ring gear of the planetary gear set. The planet carrier of the gearset is connected to both the rotating clutch and the band clutch. During CVT operation, both clutches are released permitting both the input and output to spin freely and independently. For direct drive (engine braking mode) the rotating clutch would be engaged, locking the planet carrier to the input shaft. This results in a 1:1 direct drive condition. For reverse operation, the band clutch would be engaged with the rotating clutch disengaged. This would ground the planet carrier causing the output to rotate in the opposite direction of the input sun gear. Additionally, the output speed would be reduced from the input speed proportional to the number of gear teeth in the ring gear divided by the number of teeth in the sun gear. R/S

Forward/Reversing Mechanism with 1:1 Ratio in Forward and Reverse

FIG. 61 shows a variation on the overrun/reversing mechanism. Here the planetary gearset is replaced by a spiral bevel differential gearset. This mechanism has the same kinematics as the planetary reverser except the differential gearset has no speed change in the reverse mode. This type of reverser is desirable for the Combination Overdrive/Underdrive CVT that is described in more detail below.

### Basic CVT Subunit

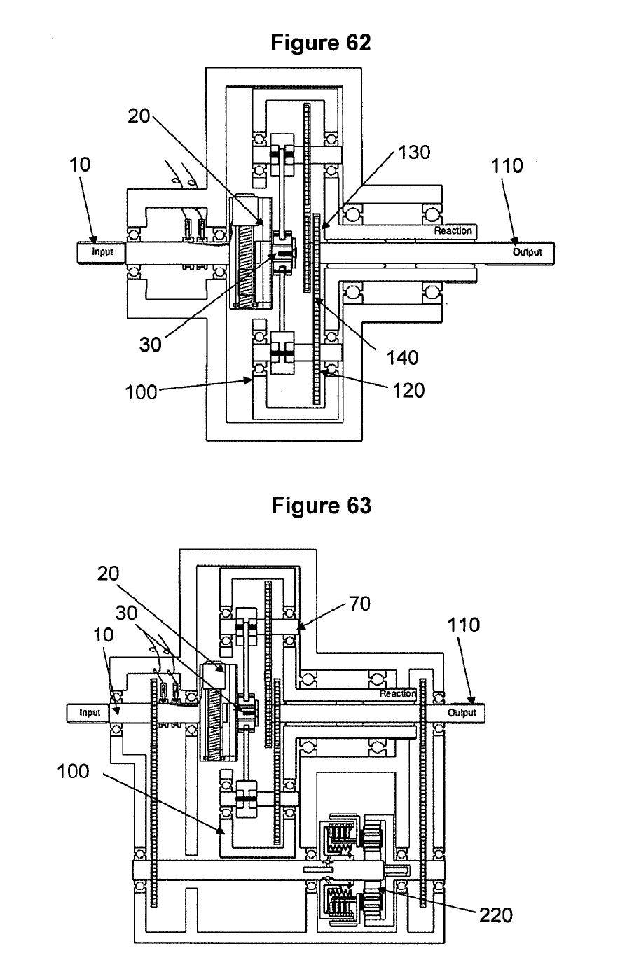

FIG. 62 is one embodiment of a complete CVT subunit. Here the main backing plate 100 for the output elements is consolidated into a rotatable unit that can transmit drive rotation externally through a hollow shaft (labeled “reaction” in FIG. 62). The input, reaction and output are labeled in FIG. 62 for the underdrive case, but as discussed earlier these can be interchanged in order to create an overdrive CVT. In underdrive mode, the application of a rotational force to the input 10 (e.g., by the motor or flywheel of a car) causes rotation of the input disk 20. Depending on the relationship between the crank pin 30 radius, the bell crank radius, and the ratio provided by the first sprocket 120 and second sprocket 130, an output is provided to the driveshaft 110. If instead a rotational force is applied to the output 110 (e.g., by the wheels of a car), the transmission can act in overdrive mode to impart a rotational force to the motor or flywheel as discussed herein.

### Basic Automotive Automatic Transmission

In FIG. 63, the basic CVT subunit, configured in underdrive mode, is coupled to the over-run/reversing unit to create a simple but practical automotive type CVT. The over-run/reversing unit 220 is connected mechanically in parallel to the CVT subunit. In most forward driving conditions the reversing unit is in neutral. The application of a rotational force to the input shaft 10 when the crank pin 30 is displaced from the axis of rotation of the input disk 20 imparts a rotational movement to the connecting rods 40, which impart rotational movement to the output shafts 70 through the bell crank and the one-way clutch as described above. Gears, chains and sprockets, or a similar mechanism connect the output shaft to the driveshaft 110, thereby imparting a rotational force to the driveshaft. When engine braking is required, the rotating clutch would be engaged, thereby transmitting rotational force from the driveshaft 110 to the input 10. It should be noted that engine braking, in this particular example, is limited to a single ratio—in this case 1:1. If reverse gear is desired, the band clutch would be engaged, the rotating clutch disengaged and the CVT must be in the 0:1 ratio state. If the CVT were in a finite forward ratio where the transmission attempts to reverse it would lock up.

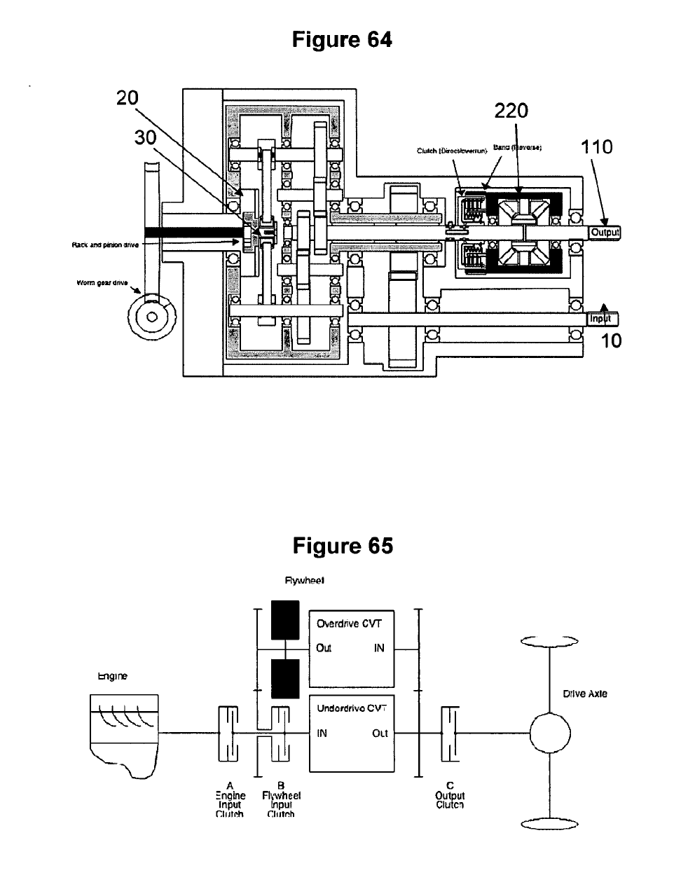

Another embodiment of a basic automotive transmission is shown in FIG. 64. Here, the over-run/reversing unit 220 is the spiral bevel differential gearset shown in FIG. 61. A worm gear drive coupled to a rack and pinion drive is used to adjust the position of the crank pin 30 on the face of the input disk 20.

### Hybrid Kinetic Powertrain System

The invention provides a novel, vehicle based powertrain system that can theoretically capture most of the kinetic energy of a vehicle during braking and then use that energy with high efficiency during subsequent vehicle accelerations. The energy storage system can capture and use most or all of the kinetic energy normally lost during braking, thereby allowing very large efficiencies to be realized. Using this invention, a practical vehicle can be constructed with an internal combustion engine downsized all the way to 10 or 20 HP. To do this, the small engine initially charges up the high efficiency storage system with enough energy to propel the vehicle up to 100 km/hr. The vehicle then accelerates to speed using this temporarily stored energy. Once at cruising speed, the small gas engine maintains the vehicle's velocity. When the vehicle needs to be braked to a stop, the majority of the vehicle's kinetic energy is stored in the storage system. When time to reaccelerate, that power comes from the storage system. The small gas engine is only used to overcome rolling resistance, aerodynamic resistance and any losses in the turnaround efficiency of the storage system.

The invention described herein makes such a system practical by providing a system that can capture and reuse the kinetic energy of a vehicle currently lost during braking with no energy conversions steps. The linear kinetic energy of the vehicle to is transformed to rotational kinetic energy in a flywheel energy storage system. To reuse this stored energy, the rotational kinetic energy of the flywheel is transformed back into linear vehicle kinetic energy, thereby re-accelerating the vehicle back up to near its original speed.

The continuously variable transmission provided by the present invention overcomes the two deficiencies of the hybrid electric vehicle to exploit regenerative braking for energy savings. First is overall turn-around efficiency. If the CVT is 90% mechanically efficient, the overall turn around efficiency would be (0.9)²=81%. Secondly, there is no physical limit to the rate at which a flywheel can accept energy flux. One need only accelerate it harder.

A vehicle described above with only a 10 or 20 HP engine would be operating at maximum load and efficiency all the time it is operating. Plus, because all of the braking energy is reused for accelerations, there would never be a situation where the engine is burning fuel at a 70 or 100 HP rate during accelerations. The small engine absolutely limits fuel consumption by its size alone.

The CVT that enables this system requires a very large ratio coverage to handle the extremely wide speed swings this system must accomplish to transform the kinetic energy in operation.

To accomplish energy transformation during braking, the flywheel, which initially would be spinning at a relatively low speed, would have to be accelerated by the output of the CVT to a very high speed of about 10,000 to 20,000 rpm. All the while, the input to the CVT from the vehicles driveline would be decelerating from an initial high speed to a relatively low speed. This necessitates a CVT with ratio coverage of 100:1 or more.

Likewise, to accomplish energy transformation during re-acceleration, the output of the CVT to the vehicle's driveline would have to accelerate from a relatively low speed to its final high speed. While this is occurring, the flywheel, which initially would be spinning at 10,000 to 20,000 rpm, would need to be decelerated by the input of the CVT to a relatively low speed.

The transmission design proposed is capable of this extreme ratio coverage. It has a theoretical range of infinity, but of course this is not possible in practice. However, ratio ranges in the hundreds are practical with mechanical efficiencies in the 90% range.

The CVT inventions provided herein provide a practical automotive transmission system that theoretically can capture most of the kinetic energy of a vehicle during braking and then use that energy with high efficiency during subsequent vehicle accelerations. This is referred to as regenerative braking. Many electric and hybrid electric vehicles make some attempt at regenerative braking, but with very limited results. There are several reasons for this. First the multiple energy conversions steps that must occur in electric systems hamper the turn-around efficiency. In an electric or hybrid electric vehicle the vehicles kinetic (mechanical) energy must first be converted to electrical energy in the motor/generator. Then this electrical energy must be converted to chemical energy in the battery systems. The systems power electronics also introduce losses. Then all of the losses in each of these conversion steps is repeated and compounded when it is time to convert the energy back to a usable form to accelerate the vehicle. This amounts to a very large net loss in efficiency. Then there is the problem of battery charging capacity. Even if the conversion losses were not so large, the amount of energy released during the rapid deceleration of a three thousand pound vehicle is more than any battery system can hope to capture. Batteries just can't be charged that fast. Some work is being done to develop ultra capacitors to accept the energy rapidly, but with an energy density approximately 400 times worse than batteries, an ultra capacitor big enough to accept all the energy from just one deceleration would be too large to install in a vehicle.

In the design described herein, vehicle braking energy is captured via an overdrive CVT into a flywheel. There are no energy conversion losses as the energy remains in the mechanical kinetic form at all times. The only losses would be mechanical bearing friction, which is typically quite low. There is also no rate limit on energy capture as it simply amounts to accelerating the flywheel at a faster rate. Also, since the flywheel need only store enough energy for one or two complete accelerations it can be of modest size and weight and be made of high strength steel rather than more exotic materials.-If a mechanical flywheel regeneration system can efficiently capture and return most of the energy from stopping a vehicle back into accelerating it back up to speed, the vehicles fuel-consuming engine could be downsized drastically. Theoretically it would be possible to downsize the engine to a size only capable of maintaining cruise velocity. This would translate to an 80 or 90 percent reduction in size, with tremendous gain in fuel economy.

Full Automotive Transmission System with Flywheel Energy Storage for Regenerative Braking

The invention also provides automotive transmission systems that have flywheel energy storage for regenerative braking.

Underdrive/Overdrive CVT Combination Automotive Transmission System

One embodiment of the automotive transmission system is shown diagrammatically in FIG. 65. It consists of:
1) An underdrive CVT to perform the normal transmission ratio changing an internal combustion powered vehicle needs.
2) An overdrive CVT to translate vehicle kinetic energy into the acceleration of a flywheel.
3) A flywheel to store vehicle kinetic energy.
4) Three clutches to change operating modes of the system.

The operating modes of this system are summarized in Table 1. Since in this system the engine is too small to accelerate the vehicle as fast as most customers expect, the first step necessary before starting a trip is for the engine to spin up the flywheel while the vehicle is stationary.

TABLE 1

| | | | | Underdrive | Overdrive |
|---|---|---|---|---|---|
| Driving Mode | Clutch A | Clutch B | Clutch C | CVT ratio | CVT ratio |
| Engine revs flywheel, vehicle | X | | | 1:1 | 1:1, then increases to |
| stationary | | | | | 0:1 |
| Vehicle accelerates with flywheel | | X | X | 1:0, then increases to | 1:1 |
| | | | | 1:1 | |
| Vehicle accelerates with engine | X | | X | 1:0, then increases to | 1:1 |
| | | | | 1:1 | |
| Vehicle decelerates with flywheel | | | X | NA | 1:1, then increases to |
| | | | | | 0:1 |
| Vehicle decelerates with engine | X | X | X | 1:0 | 1:1, then increases |
| | | | | | slightly |
| Flywheel revs during cruise | X | | X | Speed dependant | 1:1, then increases to |
| | | | | | 0:1 |
| Engine reverses vehicle | X | X | X | 1:0 | reverses |

“X” signifies that the indicated clutch is engaged

The engine is connected to the input of the underdrive transmission through clutch A. The underdrive transmission remains at a 1:1 ratio. Its output is geared to the input of the overdrive transmission, which slowly increases its overdrive ratio from 1:1 up to 1:100 and beyond. This accelerates the flywheel to high speed.

The next mode involves using flywheel energy to accelerate the vehicle to cruising speed. Here clutch B is engaged, connecting the flywheels high rotational velocity to the underdrive transmission which is initially set to the 1:0 ratio. The output does not turn regardless of how fast the input turns. Clutch C is also engaged to transmit the transmissions output speed to the vehicle drive axle. To accelerate, the underdrive ratio is now slewed from 1:0 toward 1:1. The flywheel will decelerate rapidly while the vehicle accelerates.

Once the ratio is at 1:1 the flywheel has transferred all the energy it can to the vehicle. Depending on the speed desired by the driver of the vehicle, the acceleration would typically cease long before the flywheel is exhausted. The engine is now ready to maintain the cruise condition.

For the engine to maintain cruise, clutch A and C are engaged. The engine drives the vehicle through the underdrive transmission, which is set at the appropriate ratio for the speed desired. Modest accelerations are possible with the small engine through typical control of the throttle and transmission ratio.

When it comes time to decelerate the vehicle, clutch A is released and the overdrive transmission starts to slew its ratio up—accelerating the flywheel. Higher vehicle deceleration rates can be obtained by increasing the overdrive ratio at a faster rate.

If a very long mountain grade is encountered that requires engine braking, all three clutches are engaged and the underdrive transmission is set to 1:0 ratio—putting it into neutral. The overdrive CVT is initially set to the 1:1 ratio. At this point the vehicle is back driving through the overdrive CVT to the engine. More engine braking can be obtained by increasing the ratio of the overdrive CVT. This can be used to increase engine braking up to the maximum speed of the engine.

There might be times when it is desirable to spin up the flywheel while the engine is driving the vehicle at cruising speed. This would be done if performance was more a requirement than economy and the driver always wanted the vehicle ready for another burst of acceleration (Performance Mode Driving). This would be accomplished with the same clutch A and C combination as normal cruising, but now the overdrive CVT slowly ramps up its ratio to accelerate the flywheel, but not so fast as to overpower the small engine and slow down the vehicle.

For vehicle reversing, the same clutch state of A, B and C engaged and underdrive CVT in neutral (1:0) ratio as the engine braking case is set. The one difference is the overdrive CVT is over ratio-ed into reverse mode as described earlier. The input and output invert when doing so, but that is just what we want as we are now driving backwards from the engine to the wheels through the overdrive CVT.

Single-CVT Full Automotive Transmission System

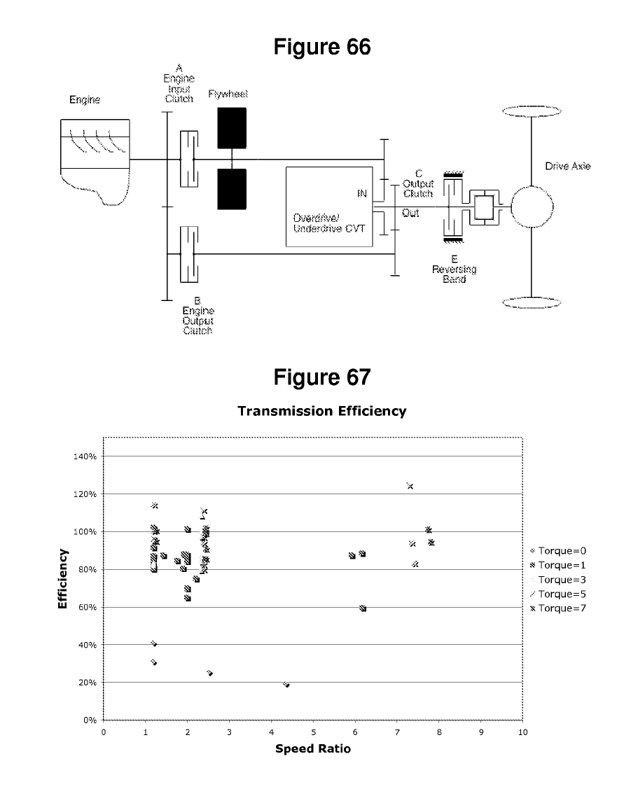

FIG. 66 and Table 2 illustrate an alternate embodiment to the above system that only requires one CVT unit that is switchable from overdrive to underdrive mode as described earlier. This system requires an output reversing gear unit but overall saves considerable hardware over the dual CVT system. The one disadvantage with this system is that some finite time is required to shift the unit from overdrive to underdrive mode. This could lead to some lost opportunity to capture braking energy if the driver switches back and forth from accelerating to braking too rapidly. The first system described with separate overdrive and underdrive CVT's can always have the ratios set at the right point to capture or release stored kinetic energy on an instants notice.

Referring to FIG. 66 and Table 2, one can see that all driving modes of the more “deluxe” version 1 system described above are obtainable.

The engine can be used to pre-accelerate the flywheel while the vehicle is stationary by applying clutch B and setting the transmission to it the 1:1 ratio in overdrive mode. The engine can then back drive through the CVT to rev up the flywheel.

Next the flywheel's kinetic energy can be used accelerate the vehicle by setting the transmission to the 1:0 ratio in underdrive mode and engaging band B. Band B engages the output reverser to negate the rotation reversal of the CVT in Underdrive mode. The CVT's ratio can now be slewed from 1:0 up to 1:1 to accelerate the vehicle and decelerate the flywheel.

Once the flywheel's kinetic energy is nearly exhausted, the clutch A can be engaged to use the remaining kinetic energy in the flywheel to start the engine. Once running, the engine can maintain the speed of the vehicle or perform modest accelerations through clutch A, the CVT and the output reverser.

TABLE 2

| | | | | | Under/Over | |
|---|---|---|---|---|---|---|
| Driving Mode | Clutch A | Clutch B | Clutch C | Band E | mode | CVT ratio |
| Engine revs flywheel, vehicle | | X | | | O | 1:1, then increases to |
| stationary | | | | | | 0:1 |
| Vehicle accelerates with flywheel | | | | X | U | 1:0, then increases to |
| | | | | | | 1:1 |
| Vehicle accelerates with engine | X | | | X | U | 1:0, then increases to |
| | | | | | | 1:1 |
| Vehicle decelerates with flywheel | | | X | | O | 1:1, then increases to |
| | | | | | | 0:1 |
| Vehicle decelerates with engine | X | | X | | O | 1:1, then increases |
| | | | | | | slightly |
| Flywheel revs during cruise | | X | X | | O | 1:1, then increases to |
| | | | | | | 0:1 |
| Engine reverses vehicle | X | | X | | U | 1:0, then increases |
| | | | | | | slightly |

If the vehicle is moving at speed and a deceleration is called for, the vehicle's linear kinetic energy can be fully captured by transferring it into accelerating the flywheel. This is accomplished by setting the CVT ratio to 1:1 in overdrive mode and engaging clutch C. The drive wheels can now back drive the CVT and as the ratio is slewed up to 0:1, the flywheel will accelerate and the vehicle will decelerate. If the vehicle needs to decelerate for a longer period of time than the flywheel can safely absorb without over speeding, either clutch A or clutch C can be engaged to utilize engine braking to retard the vehicle without a time limitation. Clutch B would be engaged if the flywheel is already absorbed maximum energy and is spinning at a speed beyond the operating speed of the engine. If the vehicle were previously set to “Hilly Driving” mode, the control system would engage clutch A immediately upon decelerating before the flywheel reached to high of a speed. This way, the CVT ratio could be used to over run the engine at a higher speed than the fixed ratio connection of clutch B for more effective engine braking without the fixed energy absorption limit of the flywheel alone.

For purposes of “Performance Mode” driving, the flywheel can be revved to maximum speed while the vehicle is cruising under engine power to be ready at all times for a burst of high acceleration. This accomplished by driving the vehicle with the engine through the direct connection of clutch B and the output reverser set to a direct drive with clutch C, while the CVT, in overdrive mode, accelerates the flywheel.

Reverse can be accomplished with either the engine or flywheel by using the same settings as forward acceleration but with the opposite setting of the output reversing gearbox.

### EXAMPLE

A prototype transmission was constructed and mounted on a test rig for the purpose of measuring power transmission efficiency. The transmission has eight output elements as diagrammed in FIG. 9 and having a gear train as shown in FIG. 46 was constructed and tested for efficiency. A one horsepower servomotor drove the input 10 of the transmission and an identical servomotor absorbed the output power. Speed on the input and output was measured directly from the servomotor encoders and the torque was assumed to be proportional to the voltage delivered to each servomotor. Torque (voltage) was commanded on a 0 to 7 non-dimensional scale. By calculation, the maximum torque (7) should be about 5 ft-lbs. A typical efficiency test was conducted by setting the torque on the output motor to a fixed resistance level of 3, 5 or 7. The input motor was commanded to run to a fixed speed of 1000 rpm. Various transmission speed ratios and output torques were measured. During the test, we measured the resulting torque delivered by the servo controller to maintain 1000 rpm on the input and measure the resulting speed from the output encoder. By multiplying speed times torque, input and output power can be calculated and divided to yield power transmission efficiency. Small torque offsets were subtracted from measured torques in the calculation to account for the servo motors internal spin losses. These were measured by spinning the motors alone without the transmission in place.

The data is graphed in FIG. 67. There is fairly large data scatter as this is a rudimentary way to measure rotating torque. Data is shown for the three output torque levels (3, 5, and 7) and speed ratios from approximately 1:1 to 40:1. Linear regression lines are calculated and displayed to attempt to look through the data scatter. As expected, the transmission is most efficient at higher torque levels and lower speed ratios. But even at a 40:1 reduction ratio, the power transmission efficiency is encouraging.

### LIST OF REFERENCE NUMBERS

10 Input shaft 130 Second output sprocket
20 Input disk 140 Chain or belt
30 Crank pin 142 Final drive shaft
40 Connecting rod 143 Reversing gearbox
50 Bell crank 145 Sliding crank pin plate
60 One-way clutch 150 Rotatably movable disk
70 Output shaft 155 Protruding dog element
80 Slot in scotch yoke 160 Piston
90 Scotch yoke 170 Cylinder
93 Secondary link 180 Adjustment sleeve
94 First secondary bell crank 190 Case ground
95 Second secondary bell crank 200 External adjustment mechanism
100 Main backing plate 210 Roller bearing
110 Driveshaft 220 Overrun/reversing unit
120 First output sprocket 230 Electric motor

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

1. A continuously variable transmission comprising:
an input shaft that rotates relative to a reference frame;
an input disk comprising a face and a rotational axis at a center of the face, wherein the input disk is operably connected to the input shaft such that the input disk rotates about the rotational axis, relative to the reference frame, when the input shaft rotates;
a crank pin movably attached to the face of the input disk, wherein the crank pin is movable between at least a first position and a second position on the face of the input disk; and
an output element that comprises:
a bell crank that comprises an arm and a pivot end;
a connecting rod that connects the crank pin to an attachment point on the arm of the bell crank;
a one-way clutch attached to the pivot end of the bell crank; and
a clutch-driven output shaft operably connected to the one-way clutch.

2. The continuously variable transmission of claim 1, wherein the first position is at the rotational axis of the input disk.

3. The continuously variable transmission of claim 2, wherein the maximum distance between the first position and the second position is less than or equal to about eighty percent of the distance between the pivot end and the attachment point of the bell crank.

4. The continuously variable transmission of claim 1, wherein when the crank pin is positioned at the rotational axis of the input disk, rotation of the input shaft does not cause the connecting rod to move.

5. The continuously variable transmission of claim 1, wherein when the crank pin is positioned at a position other than the center of the face of the input disk, rotation of the input disk causes the connecting rod to move in a reciprocating substantially linear motion, thereby causing the arm of the bell crank to oscillate in a first direction and a second direction opposite to the first direction, wherein movement of the arm of the bell crank in the first direction is transmitted by the one-way clutch to the clutch-driven output shaft and movement of the arm of the bell crank in the second direction causes the one-way clutch to slip such that the movement of the bell crank is not transmitted to the clutch-driven output shaft.

6. The continuously variable transmission of claim 1, wherein the transmission does not include a movable fulcrum between the input shaft and the clutch-driven output shaft.

7. The continuously variable transmission of claim 1, wherein the transmission does not include a lever between the input shaft and the clutch-driven output shaft.

8. The continuously variable transmission of claim 1, further comprising a driveshaft operably connected to the clutch-driven output shaft, wherein rotational motion of the clutch-driven output shaft is transmitted to the driveshaft.

9. The continuously variable transmission of claim 8, wherein the rotational motion of the clutch-driven output shaft is transmitted to the driveshaft by a rotation transmitting mechanism selected from a gearset, a sprocket and chain, and a belt and pulley.

10. The continuously variable transmission of claim 1, wherein the transmission comprises two or more output elements.

11. The continuously variable transmission of claim 10, wherein the transmission comprises two output elements, each of which comprises a connecting rod that is attached to the crank pin, wherein the output elements are positioned approximately equidistant from each other about the rotational axis of the input disk.

12. The continuously variable transmission of claim 10, wherein the transmission comprises four output elements, each of which comprises a connecting rod that is attached to the crank pin, wherein the output elements are spaced approximately equidistant from each other about the rotational axis of the input disk.

13. The continuously variable transmission of claim 10, wherein the clutch-driven output shafts of each of the output elements are operably connected to a driveshaft.

14. The continuously variable transmission of claim 13, wherein the clutch-driven output shafts are operably connected to the driveshaft by a gear mechanism.

15. The continuously variable transmission of claim 13, wherein the clutch-driven output shafts are operably connected to the driveshaft by a chain and sprocket mechanism.

16. The continuously variable transmission of claim 1, wherein the input shaft comprises a crankshaft.

17. The continuously variable transmission of claim 1, further comprising:
at least a second bell crank that comprises an arm;
at least a second connecting rod that connects the crank pin to the arm of the second bell crank; and
at least a second one-way clutch attached to the second bell crank;
wherein the second one-way clutch is operably connected to a clutch-driven shaft.

18. The continuously variable transmission of claim 17, wherein the second one-way clutch is operably connected to the same clutch-driven output shaft as the first one-way clutch.

19. The continuously variable transmission of claim 17, wherein the second one-way clutch is operably connected to a second clutch-driven output shaft.

20. The continuously variable transmission of claim 17, wherein the connecting rod comprises a Scottish yoke that comprises a slotted opening through which the crank pin is attached, and two ends, each of which is attached to an arm of a bell crank.

21. The continuously variable transmission of claim 1, wherein the transmission further comprises a backing plate to which the clutch-driven output shaft is rotatably attached.

22. The continuously variable transmission of claim 21, wherein the input shaft is fixed and the backing plate rotates about the input shaft when a rotational force is applied to the clutch-driven output shaft.

23. The continuously variable transmission of claim 22, wherein when the crank pin is positioned at the center of the face of the input disk the backing plate rotates at the same rotational speed as the clutch-driven output shaft.

24. The continuously variable transmission of claim 22, wherein when the crank pin is displaced from the center of the face of the input disk the backing plate rotates at a reduced rotational speed compared to the rotational speed of the clutch-driven output shaft.

25. The continuously variable transmission of claim 22, wherein when the crank pin is positioned on the face of the input disk a distance from the rotational axis of the input disk that is greater than fifty percent of the distance between the pivot end and the attachment point of the bell crank and a rotational force is applied to the backing plate, the clutch-driven output shaft rotates in a direction opposite to that of the rotational force.

26. The continuously variable transmission of claim 25, further comprising an overrun/reversing mechanism interposed between the clutch-driven outputshaft and a driveshaft, wherein the overrun/reversing mechanism converts the rotational motion of the clutch-driven output shaft to a rotational motion in an opposite direction.

27. A regenerative braking system that comprises a driveshaft, a flywheel, an engine, and:
a) a first continuously variable transmission configured to operate in overdrive mode to transmit rotational motion from the driveshaft to the flywheel;
b) a second continuously variable transmission configured to operate in an underdrive mode to transmit rotational motion from the engine or the flywheel to a driveshaft;
c) an engine input clutch;
d) a flywheel input clutch; and
e) an output clutch.
